(19) United States
(12) Patent Application Publication
(10) Pub. No.: US 2008/0307451 A1
(43) Pub. Date: Dec. 11, 2008

(54) Remote Controller and Audiovisual Content Access Control

(75) Inventor: Stuart Antony Green, Sheffield (GB)

Correspondence Address: BAINWOOD HUANG & ASSOCIATES LLC, 2 CONNECTOR ROAD, WESTBOROUGH, MA, 01581, US

(73) Assignee: ZOOTECH Limited, Sheffield (GB)

(21) Appl. No.: 11/791,130

(22) PCT Filed: Nov. 18, 2005
(86) PCT No.: PCT/GB05/04466

§ 371 Date: Jul. 23, 2008

(30) Foreign Application Priority Data
Nov. 18, 2004 (GB) 0425375.3

(51) Int. Cl. H04N 7/16

(52) U.S. Cl. 725/25

(57) ABSTRACT

Embodiments of the present invention relate to a remote controller for controlling audiovisual apparatus to playback protected audiovisual content. In the embodiment, the controller comprises means for receiving access information associated with the protected audiovisual content, generator means for generating playback data, using received access information, and transmitter means for transmitting a playback signal, embodying the playback data, for controlling the audiovisual apparatus to playback the protected audiovisual content. The remote controller can be used for accessing a data storage medium storing audiovisual content, the content comprising one or more audiovisual components, including at least one protected audiovisual component, and a menu component, which provides limited access during playback of the content to the protected audiovisual component, via at least one path defined by plural menu buttons, wherein the menu component has an associated time limit, and access to the protected audio-visual content via the path is permitted only within the time limit.

The present invention relates in general to hidden, obscured, protected or restricted audiovisual content and to apparatus and methods for obtaining access to that content.

In general terms, audiovisual content such as a movie or other presentation is formed by gathering together many small sections or clips of raw audio and visual content. This is usually termed an “authoring” process wherein the raw sound clips and video clips are progressively assembled and edited together to form the finished audiovisual product. The audiovisual product is then recorded on some form of recording media. Traditionally, this would be an analogue medium such as celluloid film or analogue videotape (e.g. VHS format video tape). More recently, it has become possible to record audiovisual content onto random access media including in particular optical disk media such as a DVD, HD-DVD or Blu-ray disc, or other forms of random storage such as magnetic hard drives or electrically re-writable solid state memory, for example flash memory. These random access media have many advantages in terms of size, data capacity, playback speed, image quality and so on. However, a disadvantage has also been identified in that it is relatively easy to view or otherwise access a stored audiovisual product, without authorisation.

An optical disc is a convenient storage media for many different purposes. One kind of optical disc, a DVD disc, has been developed with a capacity of up to 4.7 Gb on a single-sided single-layer disc, and up to 17 Gb on a double-sided double-layer disc. There are presently several different formats for recording data onto a DVD disc, including DVD-Video and DVD-Audio, amongst others. Of these formats, DVD-Video is particularly intended for use with pre-recorded video content, such as a motion picture. As a result of the large storage capacity and ease of use, DVD-Video discs are becoming popular and commercially important. Conveniently, a DVD-Video disc is played using a dedicated playback device with relatively simple user controls, and DVD players for playing DVD-Video discs are becoming relatively widespread. More detailed background information concerning the DVD-Video specification is available from DVD Forum at www.dvdforum.org, and elsewhere. If a reader is minded to learn about more specific features of the DVD-Video specification, he is referred to the extensive information available free of charge on the Internet, for example see http://dvd.sourceforge.net/dvdinfo/index.html, or one of the many text books on the subject, for example “DVD Demystified” by Jim Taylor, published by McGraw-Hill-Education, ISBN 0071350268. In addition, it will be appreciated that anyone intending to author a DVD product, according to aspects and embodiments of the present invention, need not have access to or even understand the DVD-Video specification in any significant detail, since DVD authoring is typically done nowadays using one of the various comprehensive DVD-Video development systems, for example DVD-EXTRA STUDIO™ or Scenarist™.

Much of the following description herein uses examples based on the DVD-Video specification and DVD-Video discs in particular. For the sake of brevity of description, therefore, unless otherwise indicated or where context dictates otherwise, the term “DVD” alone will be used hereafter to mean a DVD-Video disc. Of course, unless specifically stated, aspects and embodiments of the preset invention are not limited only to the DVD-Video specification and to DVD, since the principles taught can be far more widely applied, for example, to HD-DVD, Blu-ray disc, hard disc or solid state memory device storage.

The DVD-Video specification currently contains a number of built-in copy-protection features that aim to protect the audiovisual data content of the disc. These include Content Scrambling System (CSS), used to encrypt blocks of audiovisual data to prevent such data being played separately from the DVD-Video presentation; and Macrovision Copy Protection, used to prevent video being copied using recording devices. The DVD player implements both of these systems during playback. While these approaches are effective in protecting data content for average consumers, “reverse engineers”, who are skilled and motivated to create copies of discs or parts of discs, now easily defeat both systems.

Within the DVD-Video specification, there are no built-in facilities by which content can be held securely on a disc, whilst remaining out of the reach of a reasonably competent reverse engineer. It is, however, still possible to apply simple techniques to hide content on a DVD. For example, many commercially authored films on DVD contain so-called “Easter Eggs”, which typically comprise video or audio clips that relate in some way to the film but which are not accessible via apparent, normal menu navigation of the disc.

A DVD typically has at least one menu, sometimes called the ‘title menu’ or ‘top menu’, from which a user usually has the option to at least play the main DVD content. The DVD-Video specification permits a DVD to have as many menus as is desired by the author of the DVD. Conversely, there may be no other menus. There is no facility in the format to define a hierarchy of menus, as such. However, a de facto hierarchy can be generated by providing plural menus and defining the menus to have options to select other menus in any manner an author requires. For example, many commercially available films are produced on a DVD that has a top menu, including common options to ‘play the film’, ‘select a language’, ‘select a chapter of the film’ and ‘set other playback options’. Each option of the top menu is typically associated with a respective sub-menu, and sub-menus may provide access to further sub-menus, and so on.

DVD menus are populated by one or more menu buttons, which are defined as rectangular regions on screen that can be selected and activated. Menu buttons are visualised on screen using appropriate graphics, for example using subpictures or background content. Up to 36 buttons can be defined for a single menu. A menu button is selected by navigating, or jumping, to the button from within a current menu or from another menu. Typically, navigation from one button to another is achieved using the arrow keys (left, right, up, down) on a remote controller. Each menu button includes four directional links that determine which button on screen is selected when respective remote controller arrow keys are pressed. The links between buttons may or may not correspond to their physical arrangement on screen. In practice, of course, directional links are typically not displayed and menu navigation between menu buttons is intended to be intuitive: for example, moving from one button to a button located, physically on screen, directly below is achieved by pressing the down arrow key of a respective remote controller. Each menu button typically also has an associated command, which is selected by activating the menu button using the ‘Enter’ or ‘OK’ key on the remote controller. In general, when a menu button is selected, or highlighted, its appearance changes according to a corresponding defined ‘select state’ of the button. For example, highlighting may be achieved by varying the respective subpicture colour or intensity. Similarly, the button may be defined to change appearance when it is activated and before the respective command takes over.

Unlike normal DVD menus, Easter Eggs are hidden using unintuitive menu design. A hidden clip may be accessible by finding an obscure menu button, which may, for example, be invisible until selected or visible but not appear like other, normal menu buttons. Typically, users can find obscured menu buttons through trial and error or by reference to the now numerous Internet web sites that publish known Easter Egg information (see, for example, www.dvdeastereggs.com or http://movieweb.com/dvd/eggs/). Clearly, an Easter Egg can be used to access obscured content via a simple menu. However, even if the Easter Egg is difficult to find, a reverse engineer can easily access respective content without reference to the menu, by extracting the relevant audiovisual objects directly from the disc. Indeed, there are a number of DVD-Video interrogation software packages available that can be used to ‘rip’ each of the individual video presentations on a disc. See, for example, www.dvd-ripper.com, amongst many others. As such, it is not advisable to attempt to hide important content using an Easter Egg principle.

One way of applying greater protection to content is described in U.S. Pat. No. 6,161,179 (WEA Manufacturing, Inc), which discloses a key-based protection method for light-readable discs, wherein a disk player provides a unique key each time a disk is played. The user communicates the unique key to a transaction service, and receives an unlock key in return. The user communicates the unlock key to the disk player. The disk player then confirms that the unlock key and the unique key have a predetermined relationship, before playing the disk. This known protection method allows pay-per-view or other pay-per-use commercialisations of an audiovisual product distributed on a light-readable disk, such as in a DVD-Video specification.

There is a wide range of applications where a greater level of security and protection, over and above that afforded by the known copy-protection approaches, would be desirable. These security problems arise not only in relation to DVD-Video specification optical disks but occur in many other environments, especially where audiovisual content is recorded onto a random access storage medium.

An aim of the present invention is to provide, at least in preferred embodiments thereof, a means by which access to at least a part of an audiovisual product can be restricted, while facilitating access by an authorised user.

According to a first aspect, the present invention provides an audiovisual product, comprising audiovisual content, including protected audiovisual content and a menu component which provides access during playback of the audiovisual content to the protected audiovisual content, wherein the menu component comprises one or more on-screen menus comprising plural menu buttons and access to the protected audiovisual content is provided by selecting menu buttons in a predetermined sequence.

“Protected” herein is intended to mean at least that the associated content cannot readily be replayed using on-screen menus that are available via the menu component. For example, there may be no ‘normal’ menu button that can be used to access the content. Such content can also be thought of as being “restricted”, “hidden” or “obscured”. Preferably, such content is protected in other ways in addition. For example, the content may be arranged in a way, which renders it relatively unplayable, or at least not playable in a way, which is acceptable to a viewer. For example, the content may be split into fragments, the fragments may be jumbled, dummy fragments may be added, and/or different paths through the fragments may be provided. Then, the correct fragment playback sequence may be obtained only by means of navigating the sequence of menu buttons. For example, the menu buttons may lead to, or contribute to the generation of, a correct playback sequence instruction (for example, which is obscured among many other sequence instruction, of which most or all others are incorrect), as will be described in detail hereinafter. Then, the menu component might provide the means of accessing the correct playback sequence instruction.

According to a second aspect, the present invention provides remote controller, for controlling audiovisual content playback apparatus to playback audiovisual content, including protected audiovisual content, arranged according to the first aspect, wherein the remote controller is arranged to generate control signals for controlling the audiovisual content playback apparatus to select the menu buttons in said predetermined sequence.

Before considering aspects and embodiments of the present invention in more detail, it is worth considering the nature of known remote controllers. By way of background, remote controllers are widely used to control consumer equipment, such as music systems, CD players, video players, televisions, satellite receivers and DVD players. Indeed, nowadays, most equipment of this kind is provided at the time of purchase with a dedicated remote controller, which is programmed with all the codes necessary to control the most commonly used functions of the equipment. Other kinds of equipment and systems, for example alarm systems, lighting systems and the like can also be controlled using similar remote controllers. Herein, for convenience, any system, device, apparatus or the like that is arranged to be controlled by a remote controller will simply be referred to as “equipment”.

Nowadays, most common remote controllers employ an infrared signal format to control the equipment; therefore, the remote controller includes an infrared transmitter—typically an LED—and the equipment includes an infrared receiver—typically a photo-detector. A signal format typically comprises control codes, each represented by a different sequence of pulses, which are modulated onto an optical carrier, for example operating at 40 kHz. In some prior art remote controllers, optical carriers may be as high as, or even exceed, 400 kHz. The pulses themselves may be transmitted at a rate of around 9600 baud. Unless context, or respective description, dictates otherwise, the combination of signal format and control codes, which are used to generate the control signals that enable a remote controller to control respective equipment, will be referred to herein as a ‘command protocol’.

Different kinds of equipment, and different manufacturers of the equipment, use different command protocols: that is different combinations of signal formats and control codes. This is necessary in order to prevent one remote controller that is supplied with one item of equipment from inadvertently controlling another item of equipment.

Historically, as households have acquired more makes and categories of equipment, they have also acquired plural dedicated remote controllers, and it has been perceived as problematic to keep track of and use increasing numbers thereof.

The advent of programmable remote controllers, which are commonly referred to as Universal Remote Controllers (URC), has to some extent addressed these problems. A URC can be programmed with plural different command protocols in order to control plural kinds of equipment. A typical URC, thus, needs to be able to generate a wide range of control signals as well as wide range of carrier frequencies.

A typical URC has a traditional operator interface (such as a keypad, touch pad, touch screen or the like), and additional means, such as for example ‘mode keys’, for selecting which item of equipment to control. For example, a URC may have one ‘increase volume’ key, and pressing that key may selectively control a television, a music system or a home theatre system, depending on which mode key was selected beforehand.

While a URC removes the requirement to keep plural dedicated remote controllers to hand, it does have other perceived disadvantages.

For example, before it can be used, a URC has to be programmed to operate with each item of equipment in a household. The programming operation can be achieved, depending on the type of URC, in one or more of a number of known ways.

One known way of programming a URC is by using a ‘preset code entry’ method, as described in U.S. Pat. No. 5,872,562 (McConnell et al.). This method typically requires the URC to store all of the command protocols for the known different categories and manufacturers of equipment. The URC is typically accompanied by a booklet containing a list of the equipment that can be controlled, with each entry in the list having a respective, unique numeric identity code. In order to program the URC to control particular equipment, the user first places the URC into a ‘program’ mode and then enters the identity code that corresponds to the equipment to be controlled. The identity code associates all appropriate buttons on the URC with an appropriate command protocol for that equipment. This operation is enacted for each item of equipment possessed (subject typically to a maximum number, for example six, at any one time) so that the single URC is selectively able to control plural items of equipment.

An adaptation of a preset code entry method is described in international patent application WO/03/056531 (Lee et al.). In this the inventors propose that the act of manually setting up a URC, by selecting the command protocols, is onerous. They propose a means to automate the set-up process involving modifying remote equipment, say a television, to include an infrared transmitter, which emits a unique identification signal of the equipment, and adapting the URC to incorporate an infrared receiver. The URC is adapted to receive the identification signal, when the unit is pointed at the equipment, and automatically select the appropriate command protocol from an internal library of stored protocols. A perceived disadvantage of this kind of arrangement is the need to upgrade equipment to include the infrared transmitter and associated controller circuitry.

Another known way of programming a URC is by using a ‘learning’ method, as described in U.S. Pat. No. 4,623,887 (Welles). Unlike a dedicated remote controller, which typically employs only an infrared transmitter for transmitting control signals to equipment, a URC that can employ a learning method typically also has an infrared receiver, which is able to receive control signals from a dedicated remote controller. When set into a program mode, this kind of URC is typically aligned with and arranged to receive control signals transmitted by a dedicated remote controller in response to user operation. Data representing the signals are stored in a rewritable memory of the URC and assigned to a respective key on the operator interface. Thereafter, when the operator presses the respective key, the control signal is reproduced in order to control the equipment. This learning process is typically enacted for each key that needs to be programmed.

An alternative known way of programming a URC is by using a ‘scanning’ method, as described in U.S. Pat. No. 4,703,359 (Goodson et al.). This method relies on the URC being arranged to generate all command protocols that can (potentially) be used to control the operations of all current and future equipment. In a programming mode, the URC is controlled, typically manually, to cycle through the available codes, transmitting respective signals, until the equipment responds to a signal. When the equipment responds to a signal, the user can assign an appropriate key of the URC to the function caused by the signal. Again, this process typically needs to be repeated for each desired function.

One further known way of programming a URC involves uploading a desired command protocol from a data source, for example the Internet. Such a URC typically requires the facility to communicate with a personal computer, which can retrieve the information and transfer it, for example via a USB cable or IrDA interface, to the URC.

A new kind of URC is described in the present applicant's co-pending GB patent application no. 0423645.1, having the title “Remote Controllers” and filed on 25 Oct. 2004. The entire contents of that application are hereby incorporated herein by reference. In brief, this patent application describes a new kind of URC that can be programmed conveniently using audiovisual playback of programming codes. For example, the URC may be receptive to audible audio content and may be programmed by replaying audio content from a DVD through a television system. In principle, the audio content may alternatively be replayed down a telephone line, similar to a dialup modem, or via wires from a headphone DIN socket on playback equipment. Alternatively, the URC may be receptive to video content and may therefore be programmed by replaying video content, from a DVD, again, through a television system.

Irrespective of whether a remote controller is bespoke, insofar as it is supplied to control a particular item of audiovisual equipment, or whether it is a URC, which can be programmed to control different audiovisual equipment, such remote controllers share in common the feature that (once programmed) they respond to a control key press by transmitting a programmed control code, according to a stored command protocol, in order to control respective audiovisual equipment.

A remote controller according to some aspects and embodiments of the present invention is adapted to generate a control signal embodying playback data using received access information, in particular, for controlling audiovisual apparatus to playback protected audiovisual content.

A remote controller according to aspects and embodiment of the present invention may find application in particular when the audiovisual content to be replayed is arranged to comprise at least one item of protected audiovisual content. The content may be protected in one or more of a number of different ways, as will be described herein.

A remote controller according to aspects and embodiments of the invention may be arranged to execute a pre-defined function for generating the control signals. For example, the remote controller may calculate playback data using the access information as an input to the pre-defined function. More particularly, the remote controller may comprise a processor programmed with the function, which is executed by the processor in response to an event. The event may be an input by a user of the access information. The pre-defined function may be a hash function.

The remote controller may be arranged to store data defining one or more pre-defined functions. For example, the controller may be selectively programmed to operate with plural kinds of audiovisual apparatus and/or different items of audiovisual content. For example, the controller may be programmable to operate with different DVD films or games, each containing protected audiovisual content and requiring a different pre-defined function to access the content.

The remote controller may store a lookup table. The lookup table may contain plural playback data entries. The controller may then be arranged to access the lookup table and retrieve an item of playback data, determined by the access information, to be used to generate the control signals. For example, the controller may be arranged to access the lookup table and read therefrom a playback code, in response to an event. The event may, for example, be an input by a user of the access key information.

Preferably the remote controller is arranged to receive and store one or more lookup tables or respective entries.

Again, the remote controller may be selectively programmed to operate with plural kinds of audiovisual apparatus and/or different items of audiovisual content. For example, the controller may be programmable to operate with different DVD-Video films or games, each containing protected audiovisual content and requiring a different lookup table and/or entries to access the content.

In addition, or alternatively, the remote controller may be arranged to receive and store user data. The user data may comprise data received by the user from a remote registration host during a user registration procedure. Alternatively, or in addition, the user data may comprise or embody information that uniquely identifies the user. For example, the information may comprise a credit card number, a PIN, a digital signature or social security number.

The remote controller may be arranged to generate the playback signal using the user data. For example, the user data may be an additional input into a pre-defined function or contribute to retrieving an appropriate item of playback data from a lookup table.

The remote controller may comprise a receiver for receiving remotely transmitted access information. The receiver may be receptive to playback of audiovisual content. The content may be played back by audiovisual equipment. For example, audio content may be played through a loud speaker or through a headphone socket. Alternatively, audio content may be played over a telephone line. Video content may be played on a visual display, such as a television or computer display unit.

In some embodiments, the remote controller comprises a token reader. The token reader may be adapted to receive a removable token or interact with a token that is nearby (for example using proximity communications such as RFID). The token reader may be adapted to read information from a received or nearby token. The token reader may, for example, read information stored magnetically on a swipe card or in embedded memory on a smart card or the like.

The token reader may be adapted to interact with a received removable token. The token reader may, for example, interact with the token by transmitting challenge data and receiving response data. For example, the token may be a smart card carrying an embedded processor that uses the challenge data as an input to an embedded function, which generates the response data. In some embodiments, the response data may comprise, or at least contribute to the generation of, the playback signal.

The remote controller may be arranged to generate playback data comprising an access key.

In some embodiments in which the audiovisual content conforms to the DVD-Video format, the access key may direct the audiovisual apparatus to begin playing the audiovisual content using a particular ‘correct’ Program Chain (PGC), among many ‘incorrect’ PGCs.

The remote controller may be arranged to generate playback data comprising a sequence of menu navigation codes, for example, including zero or more menu button activation codes.

In some embodiments in which the audiovisual content conforms to the DVD-Video format, the sequence of menu navigation codes causes the audiovisual apparatus to navigate a particular path through a menu comprising plural menu buttons, wherein a user would find it difficult to manually navigate the same path. For example, the path may be difficult to manually navigate due to a requirement to step from button to button extremely quickly or because at least some of the buttons do not highlight or are invisible.

According to another aspect, the present invention provides a data storage medium storing audiovisual content, the content comprising one or more audiovisual components, including at least one protected audiovisual component, and a menu component, which provides limited access during playback of the content to the protected audiovisual component, via at least one path defined by plural menu buttons, wherein the menu component has an associated time limit, and access to the protected audiovisual content via the path is permitted only within the time limit.

In preferred embodiments, the time limit is set so that is it relatively difficult for a user to manually navigate the path. More preferably, the time limit is such that it is in practice unfeasible for a user to manually navigate the path. In this case, navigating the path may only be possible using a controller according to other aspects of the present invention.

The menu component may be further characterised by having one or more obscured or suppressed menu buttons. For example the menu buttons may be at least one of: indistinguishable from their background; invisible; or physically placed on top of one another. In addition, or alternatively, the buttons may not become visibly highlighted when selected or activated.

Access to the protected audiovisual component may be via at least one obscured or suppressed menu button.

There may be plural obscured or suppressed menu buttons and access to the protected audiovisual component may be via plural of these buttons.

In some embodiments, the protected audiovisual component may be accessed by selecting or activating an obscured or suppressed menu button.

The protected audiovisual content may comprise a plurality of cells, arranged in a non-sequential playback order, and a plurality of playback sequence instructions, only one (or a minority) of which define(s) a correct cell playback sequence, wherein access to a correct playback sequence instruction is via the at least one path of the menu component.

Other aspects and embodiments of the present invention will become apparent from the following description and drawings.

Embodiments of the present invention will now be described by way of example only with reference to the accompanying drawings, of which:

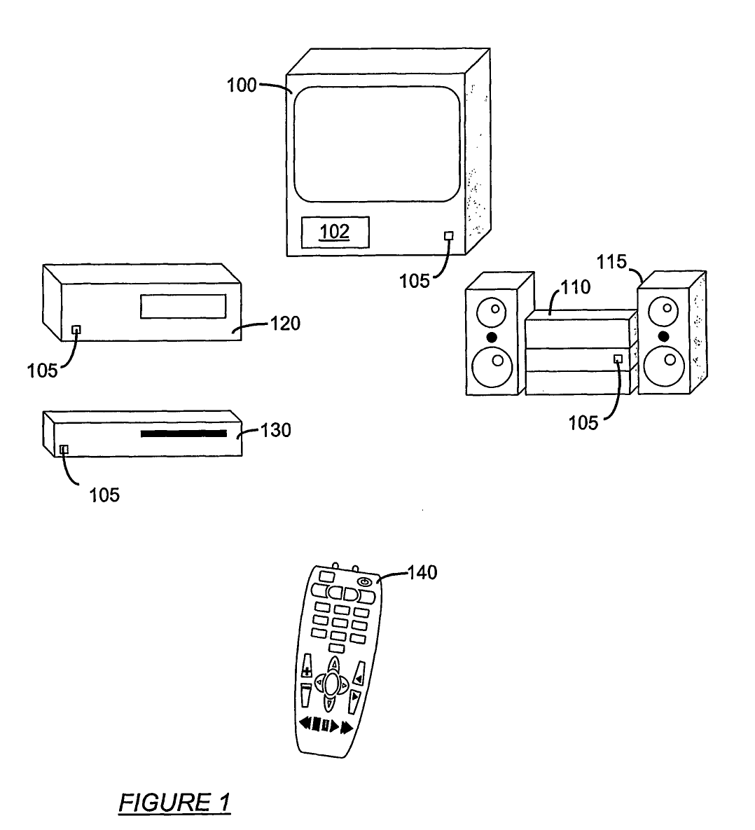

FIG. 1 is a diagram illustrating a typical home audiovisual system;

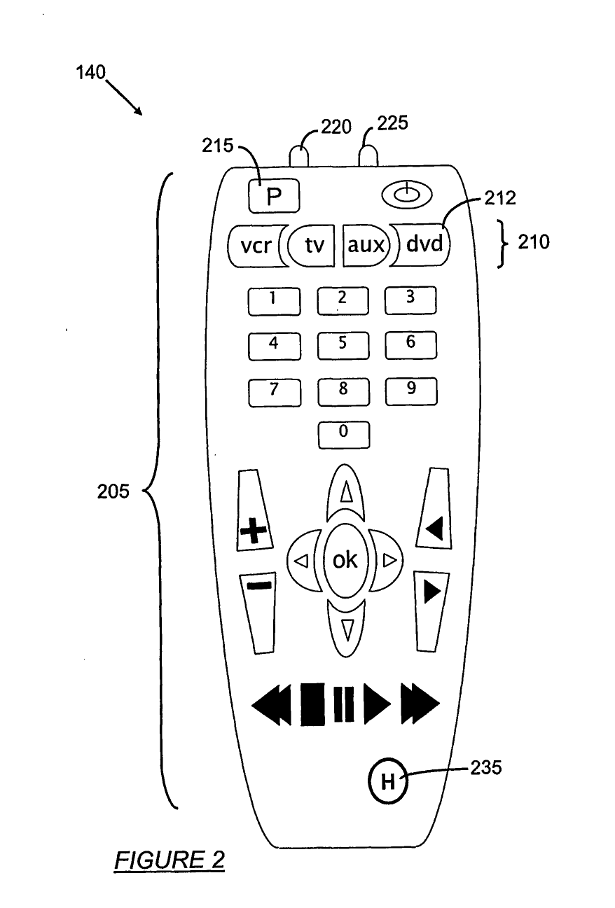

FIG. 2 is a diagram illustrating an exemplary remote controller according to an embodiment of the present invention;

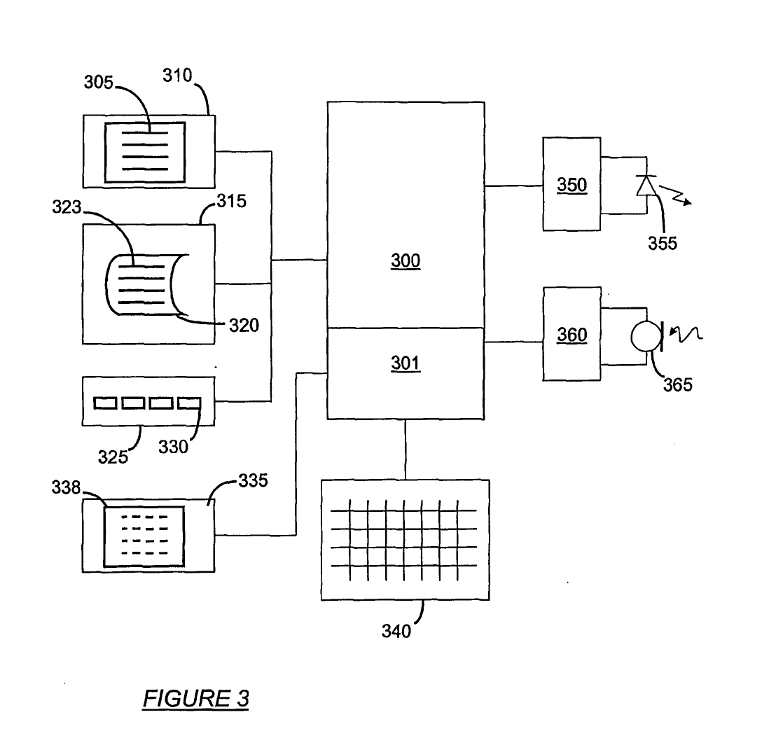

FIG. 3 is a functional block diagram illustrating the main components of the remote controller of FIG. 2;

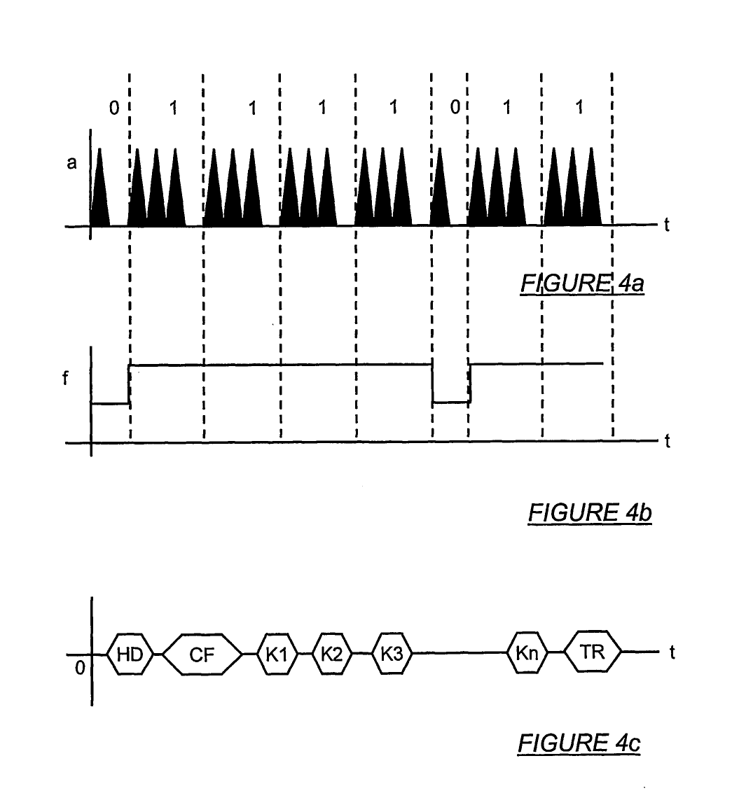

FIGS. 4a to 4c are diagrams illustrating exemplary audio frequency programming signals for programming a URC according to embodiments of the present invention;

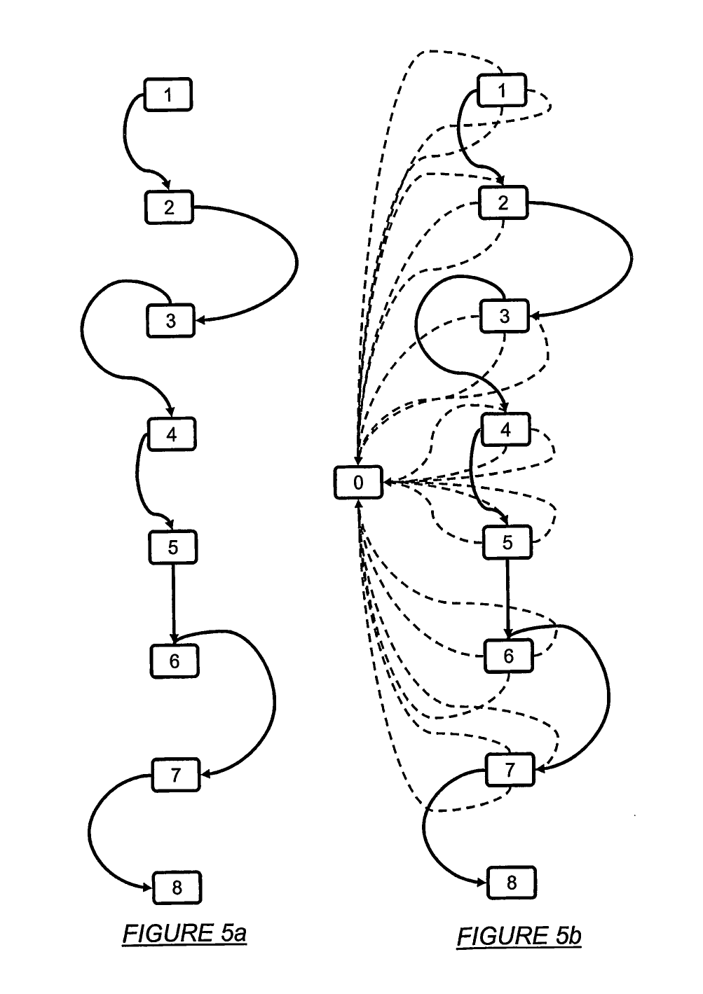

FIGS. 5a and 5b are logical diagrams, which respectively illustrate two obscured menus according to embodiments of the present invention;

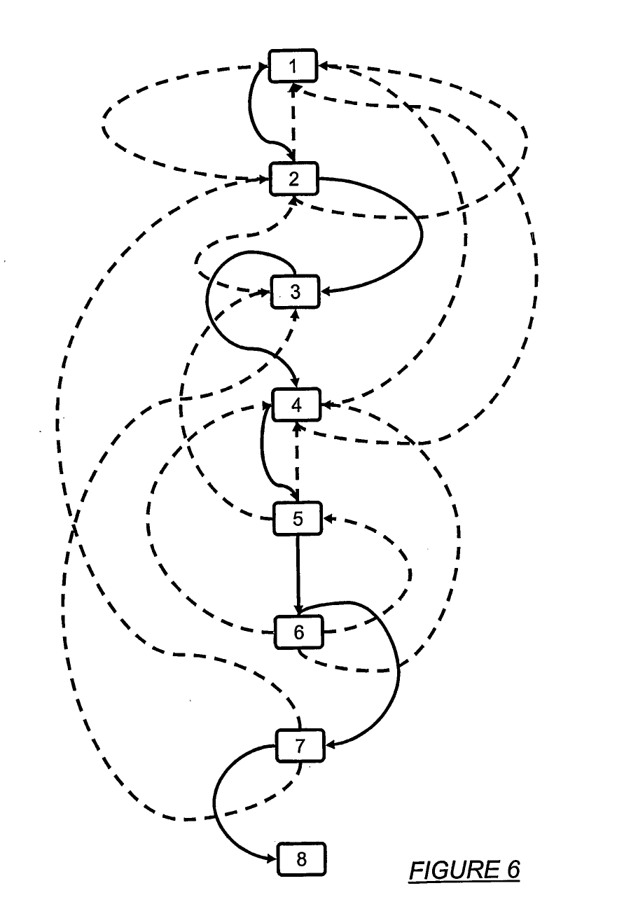

FIG. 6 is a logical diagram of an obscured menu according to an embodiment of the present invention;

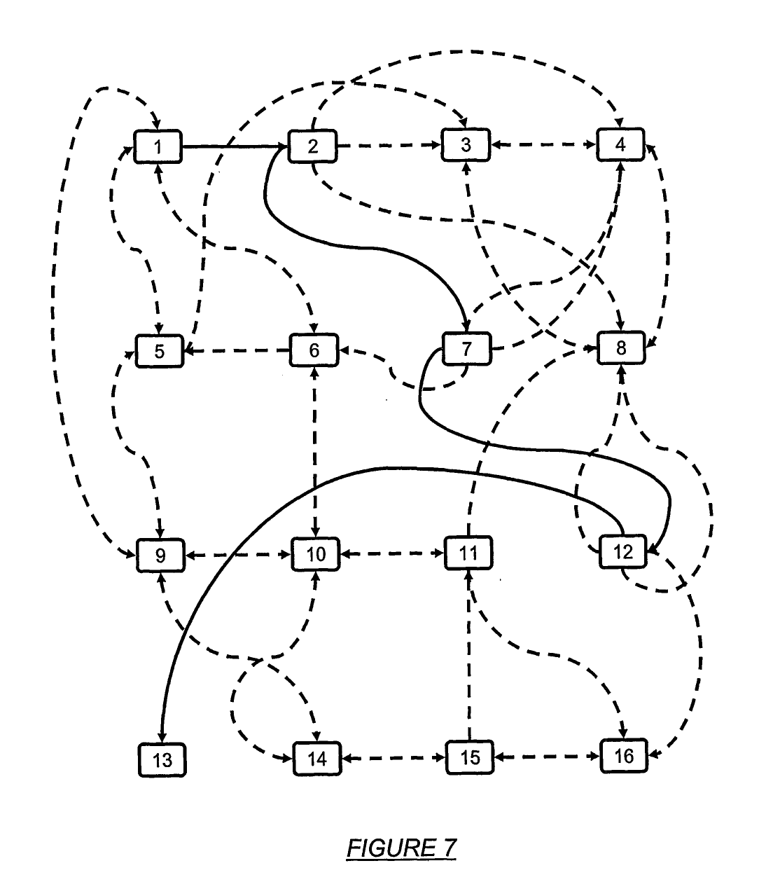

FIG. 7 is a logical diagram of an obscured menu according to an embodiment of the present invention;

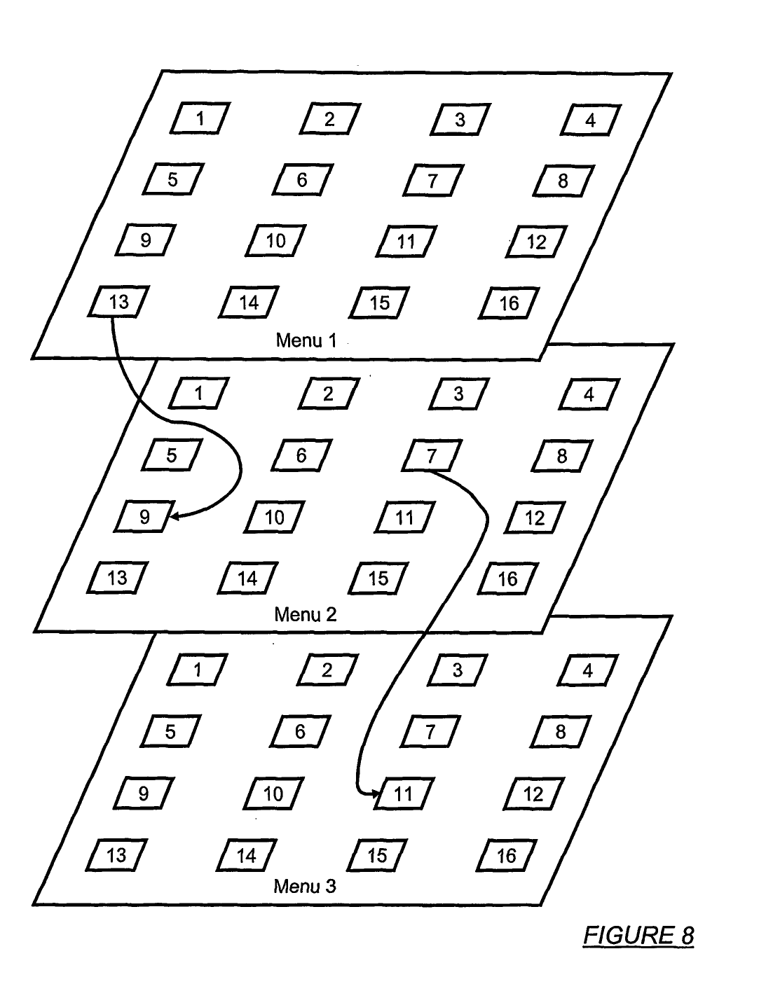

FIG. 8 is a logical diagram of an obscured menu structure, comprising three menus, according to an embodiment of the present invention;

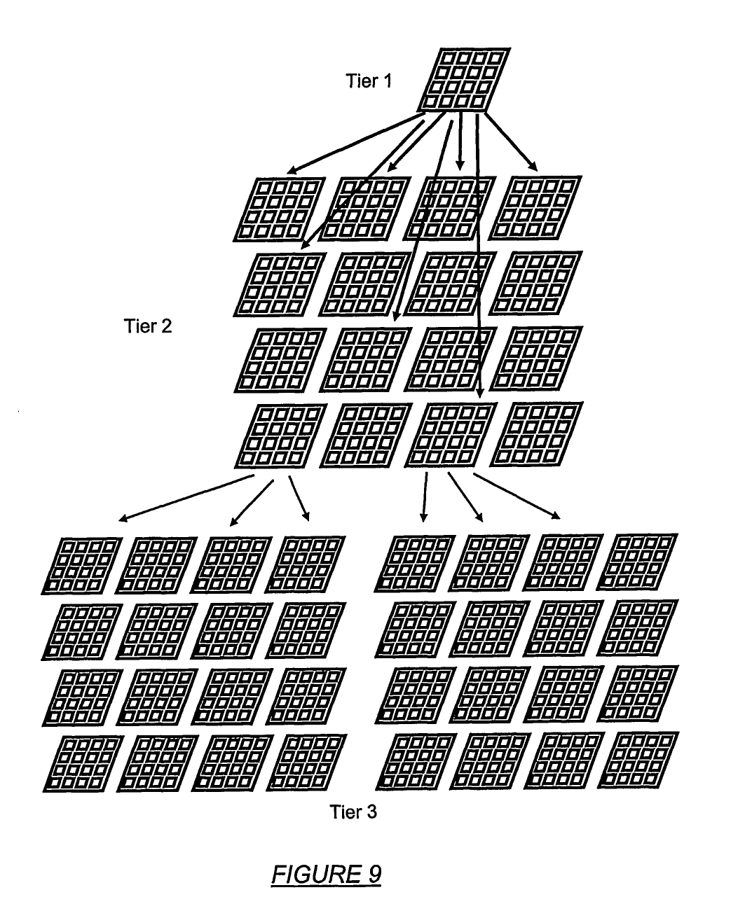

FIG. 9 is a logical diagram of an obscured menu hierarchy, comprising three tiers, the second and third of which comprise plural menus, according to an embodiment of the present invention;

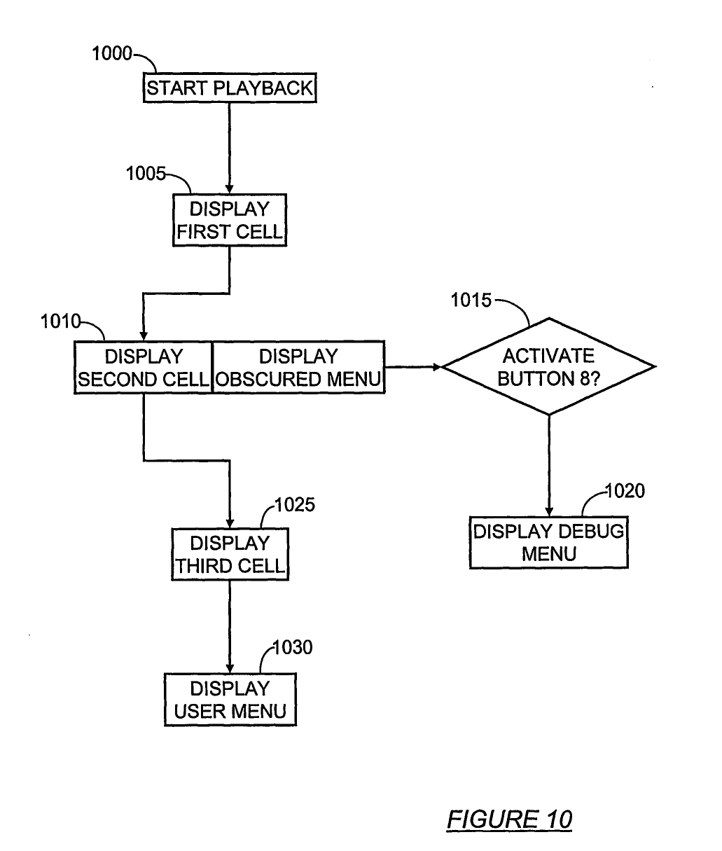

FIG. 10 is a flow diagram showing an example of how to access an obscured menu during DVD playback;

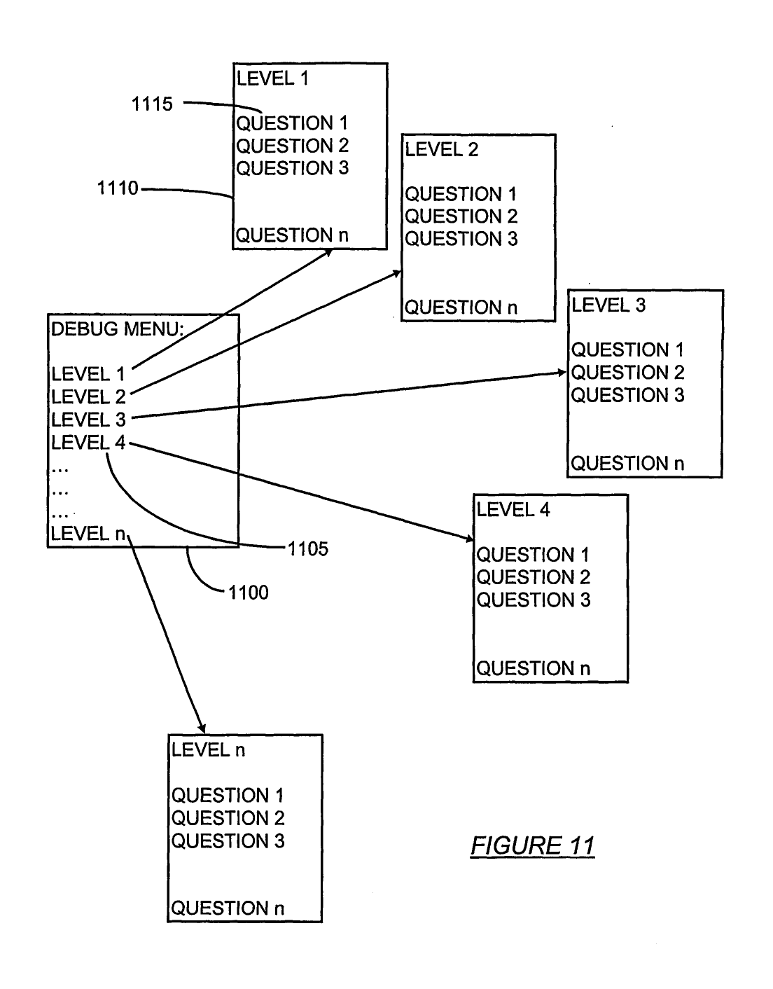

FIG. 11 is a diagram illustrating an example of an exemplary debugging menu structure;

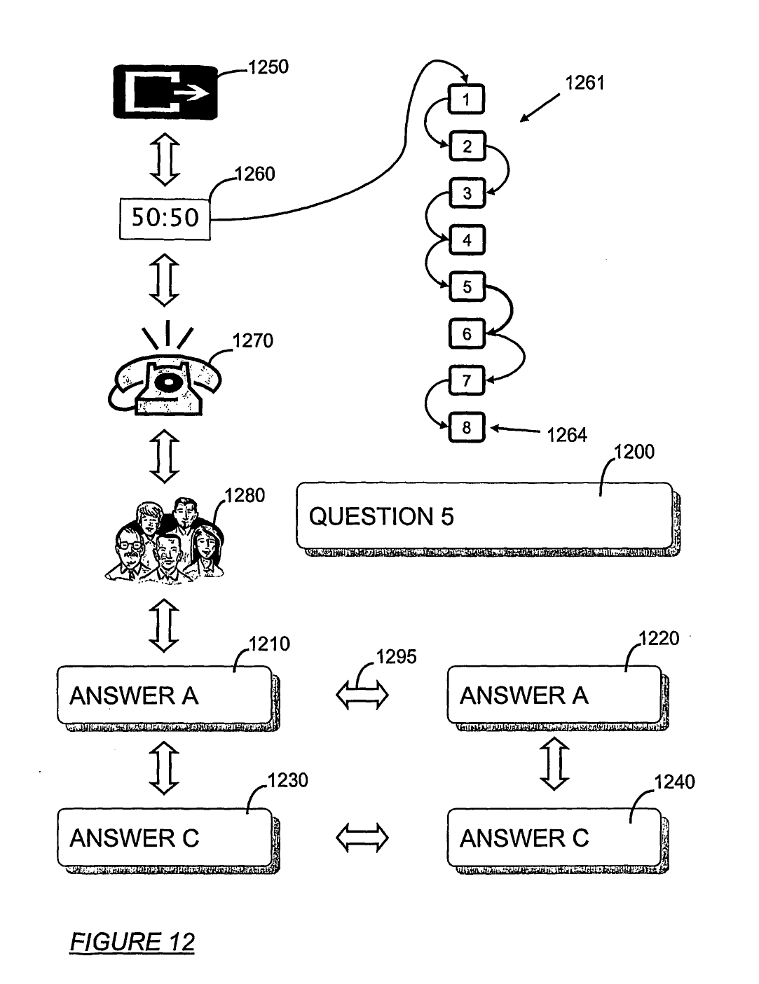

FIG. 12 is a diagram illustrating an obscured menu integrated into a DVD menu, which forms the basis of a DVD quiz game;

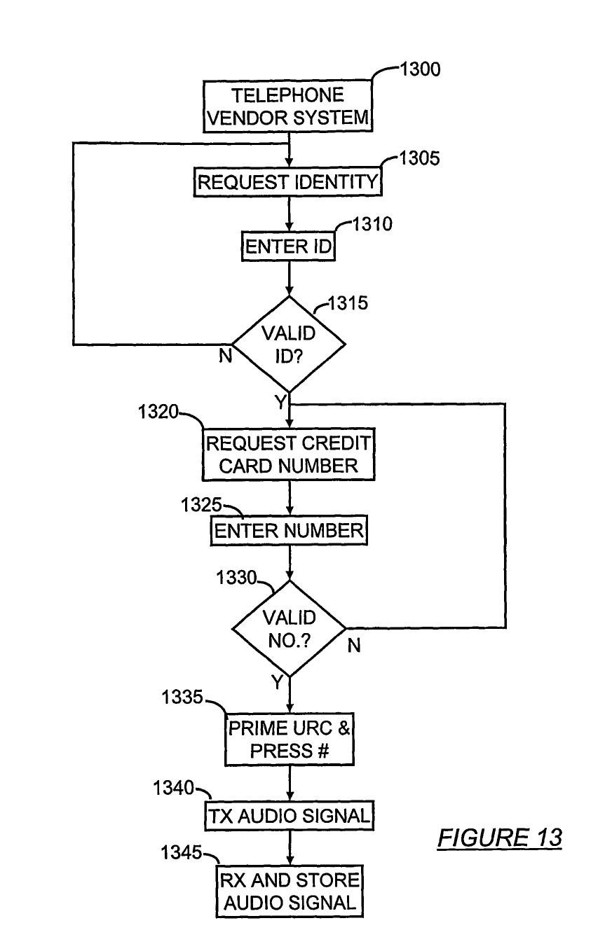

FIG. 13 is a flow diagram showing an example of programming a URC according to embodiments of the present invention;

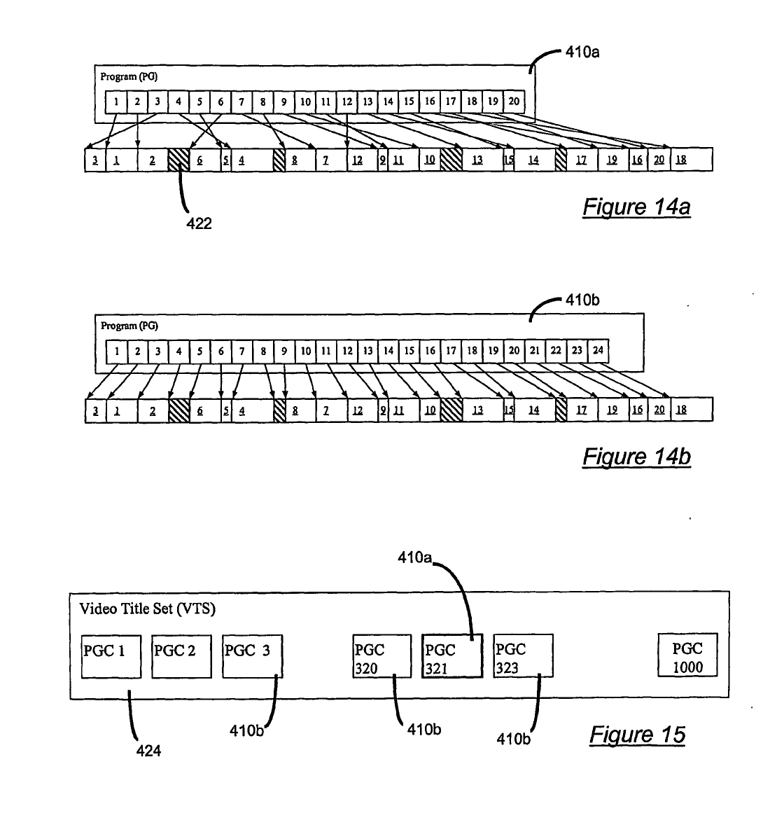

FIGS. 14a and 14b are diagrams that illustrate obscured audiovisual content and, respectively, a correct PGC and an incorrect PGC;

FIG. 15 is a diagram of a Video Title Set comprising plural PGCs, only one of which is a correct PGC for replaying obscured audiovisual content;

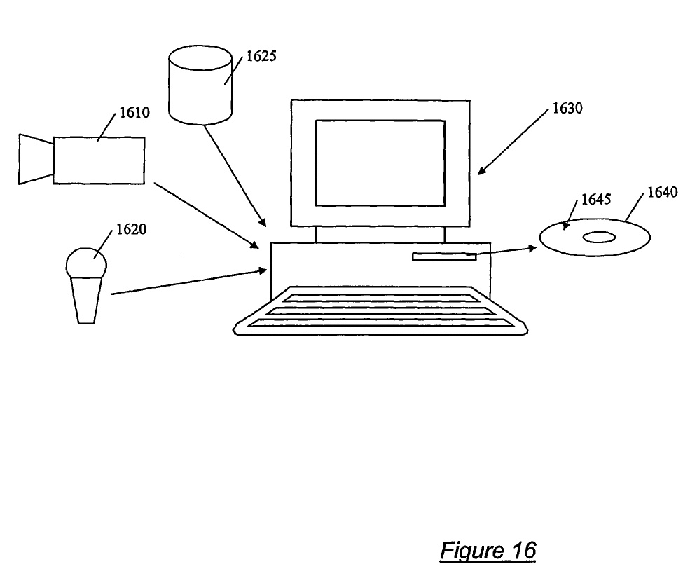

FIG. 16 is a diagram of an exemplary authoring system;

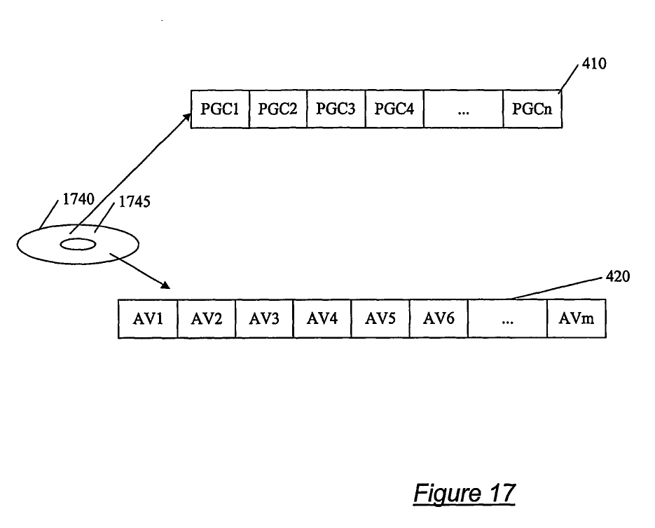

FIG. 17 is a diagram illustrating the content of an exemplary DVD; and

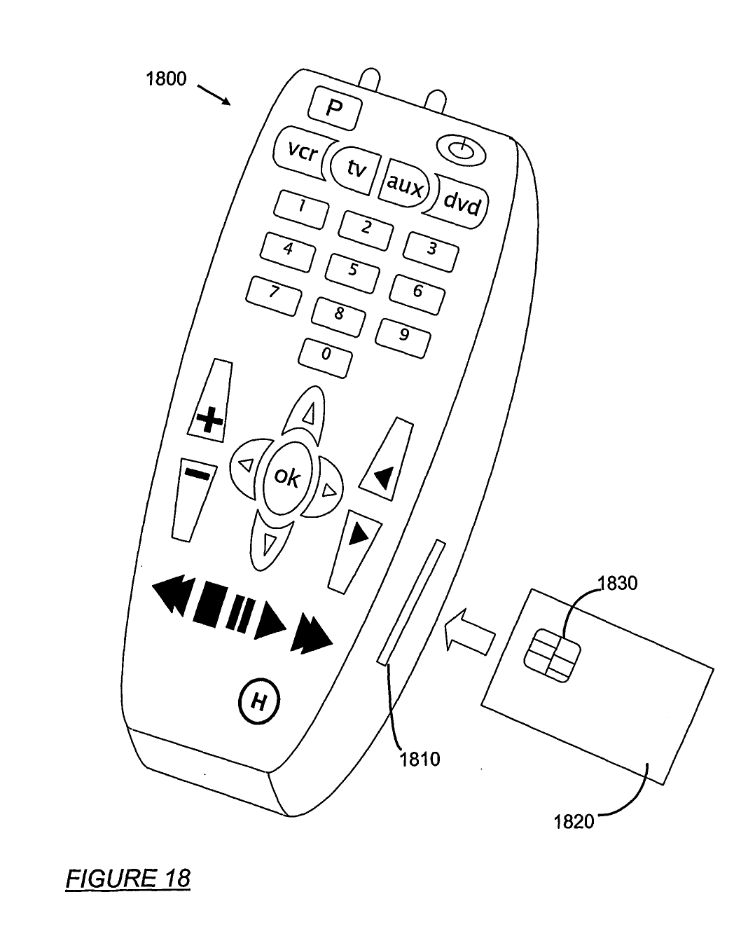

FIG. 18 is a diagram illustrating an alternative URC according to embodiments of the present invention.

The diagram in FIG. 1 illustrates a typical home audiovisual system. The system comprises components including a television 100, a stereo music player 110 with speakers 115, a videocassette player/recorder 120 and a DVD player 130. Each component is standard in the art and has an infrared detector 105 for receiving infrared signals from a respective, dedicated remote controller (not shown), which is supplied with each component. Each dedicated remote controller includes an infrared transmitter for transmitting control codes to its respective component. Alternatively, an appropriately programmed URC 140, for example as described hereinafter, can be used to control each component.

A URC according to an embodiment of the present invention is illustrated in FIG. 2. The URC is similar in many respects to many of the prior art devices, which are suitable for controlling home audiovisual systems. The URC includes an operator interface comprising a keypad 205, which, in this example comprises a plurality of keys. In other examples, the operator interface may comprise a touch screen display, or a combination of keys and touch screen. For convenience of description herein, any form of operator interface will be referred to as a ‘keypad’, having ‘keys’. Some of the keys, when pressed, generate one or more control signals for controlling the standard functions of pre-determined audiovisual equipment. Other keys control aspects of the internal operation of the URC. For example, the keypad includes mode keys 210, for selecting which component (in this case, the television (TV) 100, stereo music player (aux) 110 with speakers 115, videocassette player/recorder (VCR) 120 or DVD player (DVD) 130) to control, and a program key “T” 215, which is used to set the URC into its programming mode. In addition, the URC has a hidden content key “H” 235, the function of which will be described hereinafter. The URC also includes a transmitter 220 and a receiver 225.

A high-level functional block diagram of the URC of FIG. 2 is illustrated in FIG. 3. Lower level functional components, for example: timing circuits; power supplies; signal and address busses; control logic; decoders; and the like, which are all well-known in the art, are not described herein for the sake of simplicity of description only. Functionally, the URC according to the present embodiment includes a programmed microcontroller 300, which controls all operations of the URC 140. The microcontroller 300 operates according to program instructions 305, which are pre-programmed and stored in a first non-volatile (NV) memory 310, for example comprising a ROM memory. The microprocessor includes a generator 301, which also operates using program instructions in the first NV memory 310. A second NV memory 315, which is rewritable, contains a library 320 of command protocols 323 for a large number of different components that can be controlled by the URC 140. As already mentioned, the command protocols 323 include information describing the signalling format and control codes for each possible component.

A third NV memory 325, which is also rewritable, stores library pointers 330, which are set to point to appropriate command protocols 323 in the library 320. The pointers, in effect, select which command protocol in the library is used at any given time.

A fourth NV memory 335, which is rewritable, stores instructions, codes or data, which are used by the generator 301 to generate particular signals for controlling audiovisual equipment to playback restricted content, as will be described hereinafter. In principle, the generator 301 may alternatively comprise an independent processor, operating under the control of different instructions. The generator 301 is typically activated by a user operating the hidden content “H” key 235.

The aforementioned rewritable memories may comprise EEPROM.

The URC 140 further comprises a key matrix 340, which is responsive to the keypad 205, a transmitter circuit 350 and a receiver circuit 360.

The transmitter circuit 350 drives an infrared LED 355, for transmitting control signals. The receiver circuit 360, in this embodiment, drives a miniature microphone 365, for example a miniature electrets microphone, which is receptive to audible audio frequencies. Such microphones (and their respective receiver circuits) are commonly used in consumer video cameras, tie-clip microphones and the like and, therefore, are relatively cheap and readily available.

As the skilled person will appreciate, the aforementioned functional description of the URC can be implemented in various different ways. For example, the memory may comprise a single device or plural devices, and at least some of the memory may be integrated ‘on board’ the microcontroller. Indeed, the microcontroller may be replaced with a more flexible microprocessor arrangement.

As described in detail in the present applicant's aforementioned co-pending GB patent application (having the title “Remote Controllers” and filed on 25 Oct. 2004), the URC can be programmed, for example for the purpose of controlling different audiovisual equipment, by pressing the program key “P” 215 and then replaying audiovisual content, which is encoded with requisite information to supply equipment control codes or, indeed, entire command protocols. The URC receives the content and stores it in appropriate second and third NV memory locations.

In examples provided in the co-pending patent application, audiovisual content for programming the URC may be provided as pre-recorded data on a programming DVD (pDVD). The pDVD contains information, which is accessed during DVD playback via a series of hierarchical menus. The pDVD enables a user to program the URC to control one or more items of audiovisual equipment. As already mentioned herein, audio programming information in particular could equally be delivered over a telephone line or by other appropriate means.

The pDVD fully complies with the DVD-Video format. The pDVD can, therefore, be authored and produced using standard DVD-Video authoring tools. Most conveniently, however, the pDVD can be authored using the present applicant's DVD-Video development system, DVD-EXTRA STUDIO™, which implements highly efficient authoring procedures, some of which are described in the present applicant's co-pending international patent application WO 03/094519.

As described in the co-pending patent application no. 0423645.1, the audio content, which programs the URC, can be encoded in any appropriate manner. The code may be a simple binary code with a sufficient number of bits to identify all makes and models of audiovisual equipment. For example, the code may be 16-bits in length, providing a maximum of 65536 alternatives. Preferably, however, the code will provide a certain amount of redundancy, in order that, for example, single bit errors are identified as errors rather than valid codes for different equipment. There are many known redundancy codes suitable for this purpose. More complex error detection and correction codes may, of course, be used.

By way of example only, the code may be written as an audio stream, in which binary 1s are represented as a rapid succession of three short ‘beeps’ (monotones or audio pulses) and a single beep represents a binary 0. Each binary 1 or 0 may be separated by a short period of no sound. The amplitude against time graph illustrated in FIG. 4a represents the decimal number 123 (11011110₂, with the least significant bit leading) using this coding scheme and an eight-bit code. In some embodiments, the audio stream may include a header portion (not shown), for example a sequence of beeps or a relatively long monotone, to prime the URC to expect a code transmission, and an ending tone, or series of beeps, (also not shown) to indicate the end of the transmission. An alternative encoding scheme may use different frequencies of sound to indicate binary 1s and binary 0s. For example, the frequency against time graph in FIG. 4b represents the decimal number 123 encoded using a high frequency tone to represent a binary 1 and a lower frequency tone to represent a binary 0.

It will be appreciated that the first encoding scheme is convenient, since 1s and 0s are independently distinguishable. In other words, there is no requirement to use timing recovery or clock synchronisation in order to decode the information. In contrast, the second encoding scheme does not distinguish between two bits having the same value. As such, the second encoding scheme requires some form of timing recovery in order to distinguish between consecutive bits having the same value. Conveniently, DVD playback timing is extremely stable and predictable, meaning it is a relatively easy task to decode the signal without requiring complex clock recovery circuitry. Instead, a simple logic and timer circuit can be used to, in effect, chop a monotone into its individual bits.

It will also be appreciated that many different sound-encoding schemes may be applied to embodiments of the present invention. For example, the 1s and 0s may be distinguished by being encoded using different volumes, different cadences, or in any other appropriate combination or manner. Alternatively, the encoding need not be in binary. For example, the code may be ternary or quaternary. However, the simplicity of the present requirements means that binary is probably sufficient for the chosen encoding scheme. In general, known modem technology may be readily adapted and applied to present embodiments.

Thus far, herein, the description has been concerned in the main with improvements to the ways in which a URC might be programmed to operate various kinds of audiovisual equipment. However, these principles may be extended to areas that have, hitherto, not been addressed in the prior art or, at the very least, have not been practical using known art URC and programming methods. In particular, a URC according to embodiments of the present invention can be programmed to access restricted content stored on a DVD.

Embodiments of the present invention also relate to hidden content on a DVD and the means by which access to the hidden content may be achieved, for example, using special menus, which will be referred to herein as ‘obscured menus’. The concept of an obscured menu will now be described.

The diagram in FIG. 5a illustrates an exemplary DVD menu. The menu comprises eight menu buttons (1-8), logically arranged as a single column of eight buttons. In this example, it may be assumed that access to restricted audiovisual content may be achieved by reaching button 8. Directional links are shown diagrammatically connecting each menu button to its nearest, lower neighbour. As can be seen in FIG. 5, the links are only one-way (indicated by the arrow on a link) and do not flow intuitively between buttons. For instance, to get from the top button to the bottom button, a user has to press the left arrow key at the first button; the right arrow key at the second button; the up arrow key at the third button; the left arrow key at the fourth button; the down arrow key at the fifth button, the up arrow key at the sixth button; and the left arrow key at the seventh button.

It will be appreciated that, while the navigation route between the menu buttons in FIG. 5 is not intuitive, and it would be relatively difficult to navigate from top to bottom, with trial and error a user could learn to navigate the route.

Therefore, the menu may be adapted to make it more difficult to navigate. Firstly, the menu buttons are programmed not to change appearance when they are selected; for example, the highlight colour and intensity may not be defined, as such, or may be defined to be the same for selected and unselected buttons. Furthermore, to increase navigation difficulty even further, the buttons themselves are not displayed in a distinct manner on a display screen (although they are, of course, illustrated on the diagram). For example, the buttons may be defined to have no distinct graphical representation, to be invisible on screen or to exist at the same physical position on the screen.

Hence, it is perceived that it would be extremely difficult for a user to navigate the menu, partly since the navigation route is unintuitive, partly because there is no selected button highlighting and partly because the buttons themselves are obscured or even invisible. It will be appreciated that any one or more of these features makes menu navigation difficult.

However, even with this degree of security, with trial and error, a persistent user could learn to navigate the menu, for example, by attempting various permutations of arrow key press until the correct route is established.

A variant of the menu in FIG. 5a is illustrated in FIG. 5b. In this example, each of menu buttons 1 to 7 is defined to have four directional links, which a user may use to navigate away from the button. The correct navigation path through the menu is the same as in FIG. 5a, and the respective ‘correct’ link from each button is illustrated using an unbroken line. The three other, ‘wrong’ directional links for each button are illustrated using dashed lines. All wrong links navigate to an additional button, designated as button 0. There are no directional links that move away from button 0, meaning that any wrong navigation of the menu takes a user to a button, from where there is no ‘escape’. In other words, an erroneous move ends the navigation and, for example, the user has to re-start the menu in order to start again.

Another variant of the menu of FIG. 5a is illustrated in FIG. 6. In this example, the correct menu navigation path of FIG. 5a is made even harder to navigate by defining additional directional links between menu buttons. The same correct path is illustrated by the unbroken links. The additional links are represented by dashed links. As shown, the additional links are generally defined to take a user back up the logical column of menu buttons, which may be, physically on screen, invisible or on top of one another. In other words, whenever a user presses the wrong arrow key, he either does not move or gets further away from being able to access the restricted content.

The navigation structure of the menu illustrated in FIG. 6 can be described by the following table:

| | 1 | 2 | 3 | 4 | 5 | 6 | 7 |
|---|---|---|---|---|---|---|---|
| UP | — | 1 | 4 | — | 4 | 7 | 2 |
| DOWN | — | 1 | — | 1 | 6 | 4 | 3 |
| LEFT | 2 | 1 | 2 | 5 | 3 | 4 | 8 |
| RIGHT | — | 3 | — | 1 | — | 5 | — |

The top row of numbers in the table identifies the menu buttons and the numbers in the body of the table represent the effect of selecting an arrow key (specified by the left hand column) while the menu button at the top of the respective column is selected. Where no number exists in the table, then the respective arrow key press has no effect. The underlined numbers in the body of the table represent the correct navigation path through the menu buttons, illustrated in FIGS. 5 and 6. For example, referring to the first menu button column, there is no action unless the left arrow key is pressed, in which event the menu selection moves from the first menu button to the menu button 2; from menu button 6, the user can select left, right, up or down arrow keys, but only pressing up arrow key is correct, with the down, left and right arrows erroneously taking the selection to menu buttons 4, 4 and 5 respectively.

Obviously, any other arrangement of links between menu buttons can be chosen. For example, the menu may be arranged so that any wrong arrow key selection takes the user back to menu button 1 or even to a different menu.

To recap, there is one correct path from menu button 1 to menu button 8; the menu buttons may be indistinct, or even invisible, and may not highlight when they are selected; and any wrong arrow key selection in the menu structure may lead to no move, a backwards move, or a move to a button from which there is no escape. In order to get from menu button 1 to menu button 8 in seven moves, the user has to make seven consecutive arrow key selections, amounting to a 1 in 4⁷—or a 1 in 16384—chance that the user will guess the right path. The probability of finding menu button 8 decreases significantly (or becomes zero) if the user makes any wrong moves.

The diagram in FIG. 7 is a further example of an obscured menu structure that is difficult to traverse, particularly if one or more of the aforementioned steps to obscure the path are taken. In this example, the correct sequence of menu buttons is again identified by links represented as solid lines and directional arrows. In this case the correct path is from menu button 1 to menu button 13, via buttons 2, 7 and 12, and the respective arrow key presses are left, right, left, up. Again, additional, wrong links are illustrated by dotted lines. As can be seen in this example, some of the dotted links have arrows at each end, indicating that the links can be traversed in either direction.

Defining a menu hierarchy, as illustrated in FIG. 8, can increase the degree of difficulty of accessing restricted content on a DVD significantly. The menu hierarchy in FIG. 8 comprises three menus; menu 1, menu 2 and menu 3. Each menu is similar to the menu that is illustrated in FIG. 7, although the links between buttons within each menu are not shown for the sake of clarity only. Access to the restricted content is via button 11 in menu 3. In this instance, access to menu 2 is via activating menu button 13 in menu 1. Likewise, access to menu 3 is by activating menu button 7 in menu 2. In each menu, the route (not shown) to get to, the button that provides access to the next menu is unintuitive. Providing between menus additional links, none of which provide the correct navigation route, increases the degree of navigation difficulty even further.

An even more complex menu hierarchy can be generated, as illustrated in FIG. 9. In this example, there are three menu tiers. The menu in tier 1 is similar to that shown in FIG. 7, in that it is difficult to navigate to the correct menu button. In addition, each menu button is defined so that, if activated, DVD replay moves to a different menu in tier 2. Likewise, each button in each menu in tier 2 is defined, when activated, to move to a different menu in tier 3 (although, to reduce complexity in the diagram, only two sets of menus are shown in tier 3, corresponding to two menus in tier 2). Access to the restricted content in this example is via a menu button in one menu of tier three.

It is clear that it would be extremely difficult for a user who does not know the correct navigation path through the menu hierarchy to gain access to the restricted audiovisual content. Even if a user knows the correct navigation path, it would be onerous to navigate through plural tiers of menu, which may comprise many more menu buttons, menus and tiers of menus than have been illustrated herein. As already mentioned, in principle, one DVD menu can have up to 36 menu buttons, which can be arranged, along the lines described, to make it even more difficult for a user to navigate to a desired function. This principle can be applied to a DVD to, in effect, hide content, or to render access to the content difficult.

Access to restricted audiovisual content can be achieved by using an obscured menu in a number of different ways. In a simple form of menu, for example, the access may be achieved by navigating to a pre-defined menu button and activating that menu button. The menu button may be programmed with a command that causes DVD playback to jump to the restricted audiovisual content.

Indeed, in a particularly preferred menu structure, for example similar to the one illustrated in FIG. 9, the degree of navigation difficulty is increased to the extent it is difficult even for a user who knows the correct navigation path to navigate through the structure. This is achieved by adding an additional requirement that each move between menu buttons has to be completed within a limited period of time, which is significantly shorter than the normal pause time between user key presses. The shorter the permitted time is, the more difficult it is to navigate through the menu. The time limitation can be added by specifying that a default action occurs in the event a selected menu button is not activated or moved away from within the specified time. The default action may be to return to the first menu button of the first menu, to move to a different menu or even to end playback of the DVD, for example. In a most preferable example, the time between key presses may be so short that it is practically impossible for a human operator to navigate the menu using manual arrow key presses. Obviously, although the time for moving between menu buttons on one menu can, in principle, approach the processing capability limit of a DVD player, the time permitted between different menus needs to be significantly longer, since selecting a new menu requires the DVD player to locate and read new audiovisual content from the DVD.

According to some embodiments of the present invention, therefore, a URC may be programmed to generate the correct menu navigation code sequence. A URC programmed in this fashion enables in particular menu navigation where it would be difficult for a human operator to navigate the menu, for example due to the number of key presses required and/or time limitations in the menu. In preferred embodiments, a URC may be programmed so that it generates a correct navigation sequence in response to input of an access key by a user. Both the entered access key and the navigation sequence can be arranged to vary each time the DVD is played back, as will be described.

Different embodiments of the present invention can be applied in different scenarios, as will now be described.

### Scenario 1—Debugging DVD Content

An obscured menu may be useful in debugging DVD content during its authoring process. During debugging it is sometimes desirable to isolate a section of functionality or code in order to test that code. In some cases, the content may only be reachable in the normal execution path of the DVD via a convoluted and time-consuming series of steps. For example, the DVD content may comprise an interactive quiz game in which there are many questions and many levels of play; advancement to a next level is only possible after successfully answering a series of questions in a previous level. A test engineer would not wish to navigate through many levels of play in order to test the later question levels, even if answers to all questions were provided. In such a scenario, an obscured menu may be used to, in effect, short-circuit the game play and permit the test engineer to advance immediately to higher levels of play without incurring the overhead of having to advance through lower levels. In this exemplary scenario, an analogy can be drawn to the notion of “cheats” that are sometimes incorporated into videogame software. A “cheat” is usually a convoluted series of operations that enables a certain condition to be set (for example, so that the user jumps to a specific level of the game; 10,000 points are added to the score; lifelines are reinstated, etc) that may be provided specifically for testing purposes.

In a simple debugging scenario, as illustrated in the flow diagram in FIG. 10, a DVD is arranged so that, in step 1000, playback is started and an initial video sequence, say an FBI warning, automatically plays. For instance, the warning may scroll up the screen. In this example, the video sequence lasts for 8 seconds and comprises three sequentially played cells; arranged as a two second cell, a four second cell and a two second cell. The second cell is defined to include the obscured menu of FIG. 5a, in which all the menu buttons are invisible, and access to a debugging menu is achieved by navigating to and activating button 8. There is no such menu associated with of the first and third cells, however. Therefore, in effect, the obscured menu appears (albeit invisibly) after two seconds of replay of the FBI warning and then disappears after a further four seconds of replay.

In step 1005, the first cell of the FBI warning plays for 2 seconds. In step 1010, the second cell plays, so that the FBI warning continues and the obscured menu is displayed, with, as a default, button 1 being selected. Of course, the term “displayed” in this context does not imply that the menu is visible to the user. During the four-second playback of the second cell, the user has an opportunity to navigate through the obscured menu and activate menu button 8 by pressing the OK button on the remote controller. If the user achieves this, then playback of the FBI warning is replaced by a display of the debugging menu, in step 1020, this time in a manner visible to the user (or test engineer). Otherwise, after the four seconds of playing back the second cell, the third cell is replayed and the obscured menu disappears, in step 1025. After playback of the third cell, for example, a normal user menu for the DVD is displayed, in step 1030.

In this scenario, the debug menu, which is illustrated schematically in FIG. 11, gives the user the opportunity to start playing the quiz game at any selected question or level. In particular, the menu comprises a first menu 1100 comprising menu buttons 1105, which permits the user to select a level (1-n). Each button 1105 points to a respective second menu 1110, which comprises buttons 1115 that permit the user to jump to the particular question (1-n) of the selected level. Selecting and activating a button 1115 from a second menu causes the DVD to initiate playback of the DVD from that selected level and question.

Using this process, the user is provided with (a) a limited window within which the buttons must be pressed, and (b) no obvious cues when the obscured menu is displayed. In combination, this enables a DVD to be authored to provide a satisfactory debugging capability, which is securely hidden from normal users.

If the obscured menu has many more buttons or comprises plural menus, then it is likely that manual navigation within the four seconds available would be impractical. In this case, the preferred, or indeed only practical, method of navigating through the menu may be by providing a URC that is programmed to navigate the menu. For example, the URC may be appropriately programmed so that the act of pressing the play button (1) transmits the play signal, which begins playback of the DVD and (2) after a pause of 5 seconds, to ensure that the second cell is being replayed and the obscured menu is displayed, transmits the correct sequence of arrow key codes and a final OK key signal, in order to cause a jump to the debug menu.

The facility to program a key to generate multiple key press signals in this manner is already known in the URC art in association with programming URC ‘macros’, which are commonplace on many current URC models. One way of programming macros is described in more detail in U.S. Pat. No. 7,587,067. In this way, a normal URC may be programmed to access the aforementioned debugging menu.

This simple scenario, in effect, provides a cheat, by which a test engineer can short-circuit normal game play in order to make the test and debug process more efficient. The cheat is sufficiently complex that it is unlikely that a normal user could find the debug menu. Since the engineer will know the route through the obscured menu, it would be possible to program a known URC with all the codes necessary to run the process.

In alternative scenarios, the debug menu may be accessed at any time during DVD playback through a short sequence of arrow key presses when a pre-determined menu button is highlighted. Even if a user accidentally finds the obscured menu, it is unlikely that they would be able to navigate through it. Again, limiting the time between key presses and providing a pre-programmed URC to complete the three key presses and then navigate the obscured menu would be advantageous.

Consider for example a game produced on a DVD-Video disc, for example the well-known “Who Wants To Be A Millionaire” DVD-based quiz game (DVD catalogue number 9208894, distributed by Universal and published by ©2003 ZOO Digital Publishing), which is based on the original television quiz game show bearing the same name. In this game, a user (or player) advances, and ultimately wins, by selecting the correct answers to fifteen consecutive questions. As illustrated in the diagram in FIG. 12, each question is displayed on screen as a menu comprising four possible answers: Answer A 1210, Answer B 1220, Answer C 1230 and Answer D 1240. A player navigates to their selected answer on the screen by using the up, down, left and right navigation (or arrow) keys, on all standard DVD player remote controllers, and selects the answer by pressing the “OK” key. The player is also provided with four additional options: “Walk Away” 1250, “50:50” 1260, “Phone a Friend” 1270 and “Ask the Audience” 1280. The “Walk Away” option ends the game; the “50:50” option causes the game to identify two incorrect answers, thereby reducing the chance of ‘guessing’ a wrong answer; and the “Phone a Friend” and “Ask the Audience” options purport to assist in answering a question by simulating a response from a friend or a quiz show audience. Overall, therefore, for each question, the player is provided with eight possible responses (1210-1290), and the means of navigating through the responses on screen is by using the arrow keys (illustrated in the diagram by block arrow symbols 1295) on a DVD player remote controller.

Also shown in FIG. 12 is an obscured menu 1261. The obscured menu has eight buttons, defining a single navigation path using seven consecutive left or right arrow key presses: left from button 1, right from button 2, left from button three, left from button 4, right from button 5, right from button 6 and left from button seven. Although additional directional links are not shown, any wrong left or right arrow key press takes the user back to the 50:50 button 1260. Also, an up arrow move from any button takes the user to the Walk Away button 1250 and any down arrow move takes the user to the Phone a Friend button 1270. Finally, the menu buttons are placed, physically on screen, at the same location as the 50:50 button 1260. While the menu buttons are invisible, and have no image associated with them, they are defined to highlight when selected. The highlights are exactly the same size, colour and brightness as the highlight for the selected 50:50 menu button.

Given this definition, the obscured menu is invisible to the user and any (accidentally) correct move through the menu has no effect on the appearance of the screen: since any highlighted button in the obscured menu simply maintains the appearance that the 50:50 menu button is selected and highlighted. Any up or down arrow key operation, when (accidentally) in the obscured menu structure, simply moves the selection to the Walk Away or Phone a Friend menu buttons respectively, giving the appearance to a normal user that the move is correctly away from the 50:50 button. As indicated, any erroneous left or right move simply takes the user back to the 50:50 button, with no apparent change to the user.

In other words, the only way to navigate successfully through the obscured menu is to complete all eight key presses and then activate button 8 by pressing the OK key. By activating button 8, a debug menu of the kind illustrated in FIG. 11 is loaded and displayed. In this example, use of a programmed URC to access the debug menu is not as necessary from a timing perspective, but could be useful if the obscured menu is more complex.

### Scenario 2—Unlocking Content

As has already been stated, within the DVD-Video specification, there are no built-in facilities by which content can be held securely on a disc, whilst remaining out of the reach of a reasonably competent reverse engineer. The present inventors have appreciated that access control may be applied using obscured menus either alone or in combination with the principles described in applicant's co-pending international patent applications WO2004109680, WO2004109678 and WO2004109679, the entire contents of which are hereby incorporated herein by reference. According to these applications, access to audiovisual content can be restricted by hiding, or obscuring, the means by which the content can be accessed. In one embodiment therein, the obscured audiovisual content is split up into relatively short cells, and the cells are jumbled up into a non-sequential order. Access to replay the cells in the correct order is provided by a valid sequence instruction, which is part of the stored content and which specifies the correct playback order of the cells. The valid sequence instruction is obscured from the user, or a reverse engineer, by providing a significant number of other, invalid sequence instructions. In order to replay the content successfully, so that the cells are replayed in the correct sequence, a user or reverse engineer either needs to know the location on the DVD of the valid sequence instruction or be willing to attempt to locate the valid sequence instruction through a significant amount of trial and error. In some embodiments, in the co-pending applications, access to the valid sequence instruction requires third party interaction. For example, the DVD is authored so that access to the valid sequence instruction requires input by a user of a playback key, which is acquired by the user from a vendor of the product, for example over the telephone. For example, the user purchases the DVD, telephones the vendor, pays a fee using a credit card and in return is provided with the playback key. The user plays the DVD, which provides a playback key entry menu and enters the playback key using the keypad and the DVD player is controlled to use the valid sequence instruction to replay the content. This example has the disadvantage that once the user knows the access key he can replay the DVD any number of times or even supply the access key to other users, who can then avoid paying for the key themselves.

A more secure variant of the aforementioned method requires the DVD to be authored to generate during playback an access key, which comprises a random number. The user uses a similar process to obtain the playback key over the telephone. However, in this example, the vendor generates a playback key using a lookup table, which contains a playback key for each possible access key, and returns the playback key to the user. The user enters the playback key and the DVD player uses a simple hash operation, which uses the playback key and the access key, to identify the valid sequence instruction. An advantage of this method over the previous method is that a different playback key is required each time the user plays the DVD, on the basis that a different access key is generated on each playback. Hence, a user is unlikely to be able to use the same playback key twice and, equally, is unable to usefully pass a playback key on to others. Additional and even more secure methods for obscuring and accessing DVD audiovisual content are described in the applicant's aforementioned international patent applications.

According to the following examples, a URC is arranged to generate a playback key for accessing restricted content on a DVD, which has many alternate playback sequence instructions. The examples are based on embodiments of the aforementioned three co-pending international patent applications, wherein restricted audiovisual content is obscured by being split into cells, having the cells re-arranged and providing many sequence instructions for replaying the cells in different orders, where only one of the sequence instructions replays the cells in the correct order. Of course, the methods taught herein would be equally applicable in general to identifying a correct one from many sequence instructions, irrespective of how the audiovisual content had been split up and re-arranged.

### EXAMPLE 1

The first example uses a pair of keys as follows.
1. When the DVD is played, the DVD displays an access key, which could be, for example, a four-digit code chosen at random by the player at run time.
2. The user enters the access key into the URC, using the keypad. For each access key, there is a respective replay key; and all possible replay keys are pre-defined and are stored in the fourth NV memory 335 of the URC in the form of a lookup table 338.
3. The user then presses the “H” key 235, which causes the generator 301 to access the lookup table 338, on the basis of the access key, and extract a replay key, which the URC then transmits to the DVD player.
4. The DVD player receives the replay key and computes the position of the respective valid sequence instruction, which replays the restricted DVD content in the correct manner.

Many algorithms are available for generating matching pairs of security keys, such as public/private key pairs. A characteristic of this exemplary access method is that a new access key will be generated for each session of playing the DVD and replay keys are unique to each access key. This means that, having the entire lookup table in the URC, the user can unlock the DVD content many times (i.e. pay-once-play-many-times). Meanwhile, the user is unable to pass usable replay keys to other users.

The lookup table may be provided in a URC that is supplied with the DVD or it may be programmed into the URC in a process of the kind that will now be described with reference to the flow diagram in FIG. 13.

In a first step 1300, a user telephones the vendor using a telephone number that accesses an automated access key system. In step 1305, the system answers the call and responds by requesting a unique identity code, for example, which is provided with the DVD. The user enters the code using the telephone's numeric keypad, in step 1310. The system evaluates the identity code in step 1315. If the number is not valid, the process returns to step 1305, and requests the number again. If the number is valid (i.e. is recognised as being associated with a known DVD), the system requests a credit card number of the user in step 1320. Again using the numeric keypad, the user enters the credit card number in step 1325 and, in step 1330, the system validates the credit card number. If the credit card number is not valid, the process returns to step 1320 to re-request the credit card number. If the credit card number is accepted, then, in step 1335, the system informs the user to place the microphone 225, 365 of the URC next to the earpiece of the telephone handset, set the URC to ‘Program Mode’ by pressing the program button “P” 215 and then press the hash key “#” on the telephone keypad. The program button primes the URC to expect an audio transmission. In step 1340, after the hash key has been pressed, the system transmits an audio signal containing lookup table data for the particular DVD. In step 1345, the URC receives the audio signal and stores the respective code information in the lookup table 338 of the fourth NV memory 335. The audio transmission ends with a signal that the URC understands is an end-of-transmission signal.

In the foregoing example, instead of (or as well as) using a credit card number, the system may require a code, which uniquely identifies the URC. For example, each URC may be programmed during or after manufacture with a unique serial number. The serial number may be used by the system to generate a lookup table, which can only meaningfully be accessed by the URC that has that serial number. The URC would also use the serial number to access the lookup table. This step adds an additional layer of security to the process.

In alternative embodiments, the URC may be provided with a speaker as well as a microphone, and be programmed to undertake duplex communications with the vendor system at the other end of the telephone line. It will be appreciated that providing the facility for such duplex communications would, for example, enable the URC to inform the system if a transmission error had occurred and automatically request retransmission. Indeed, the URC may be adapted to plug, via a cable, directly into a telephone socket, in order to communicate with the system.

### EXAMPLE 2

The foregoing example can be modified to allow the access key to be entered by the user using information that is either unique to that user or restricted to a small number of users. Examples are:
1. A ‘customer number’ allocated to the user, which can be traced (suitable for corporate use, for example).
2. A credit card number of the customer (which the customer is unlikely to circulate to others).
3. A unique identity or serial code associated with each URC.

During playback, the content on the DVD will cause the player to undergo authentication and will either play valid video if authentication succeeded or some other video if it failed.

### EXAMPLE 3

To support preferred embodiments of the present invention, certain steps are taken during the preparation of content for the DVD (i.e. authoring), and particular steps are taken during playback to unlock the content for authorised users.

During authoring, the DVD content may be prepared as follows:
1. Define a destination function D, used to determine the destination on the DVD of a correct sequence instruction to play the content in the correct order, that meets the following requirements:
   a. D is parameterised by n values C₁, C₂ . . . Cₙ where each of these values corresponds to a separate access key component that together will be used for unlocking the content.
   b. The result of D when evaluated for all possible values should lie in the range 1 to m. Larger values of m will usually result in higher levels of protection of the content.
   c. The range of each code Cᵢ is such that, in combination C₁, C₂, . . . Cₙ, there are a very large number of possible input values to D.
   d. There is a certain combination of values of C₁′, C₂′, . . . Cₙ′ (the ‘unlock code’) that ideally results in a unique output from D, D_{unlock}=D(C₁′, C₂′, . . . Cₙ′). If D_{unlock} is not unique for all values C₁, C₂, . . . Cₙ, (ie. there are multiple unlock codes), then ideally there should be as small a number of possible such combinations of values that result in D_{unlock}.
2. Create m destinations (and respective playback instructions) for program execution with the following properties:
   a. Destination D_{unlock} corresponds to the unencumbered playback of the protected content.
   b. All other destinations result in playback of alternative or spurious content.

During playback of the disc the following steps are performed:
3. Obtain access keys C₁, C₂, . . . Cₙ.
4. Determine destination D(C₁, C₂, . . . Cₙ).
5. Jump to destination.

The codes C₁, C₂, . . . Cₙ can be drawn from any of the examples given above, including any combination of the following:
i. A PIN number supplied to the user. This could take the form of a simple four-digit code, for example. A user interface provided on the DVD may provide prompts by which the user enters each of the four digits in turn. This may be provided by a visualisation of a numeric keypad with which the user must use the standard DVD-Video remote control buttons (up, down, left, right, OK) to select the sequence of digits. Alternatively, the codes could be entered using menu navigation, as will be described in detail hereafter.
ii. A number that is specific to the current execution, which can be derived from a DVD player random number generator.
iii. A number that is private to the user, such as a credit card number, or a customer code. This number would be entered in a similar way to item above.

### EXAMPLE 4

Various approaches are possible for defining the destination function D. For example, a crude function would simply return a success/fail outcome based upon, say, a PIN number. The following pseudo-code returns 1 if the user enters the valid PIN code “1234” and 2 for all other codes.

Function D(C)
{
if C = 1234 then return 1 else return 2
}

On the disc two destinations (1 and 2) would be set up, with 1 corresponding to the unlocked content proper, and 2 corresponding to some alternative content, such as a still image with the text “Access Denied”. This approach would provide a very low level of protection, since it would be trivial for a reverse engineer to identify both the correct unlock code and also the destination on disc for the protected content. The advantage of the approach is that it is very simple to implement, requiring simple authoring and playback methods. Therefore, this approach is adequate when security of the content is not an important requirement.

### EXAMPLE 5

A slightly more secure approach is to use a one-way Hash function, which is a function H that maps a message M (usually of arbitrary length) to a fixed length ‘message digest’ where:
1. H(M) is easy to compute,
2. given any message digest MD it is hard to find a corresponding message M where MD=H(M); that is H is not practically invertible, and
3. given M and H(M) it is hard to find a message M′≠M such that H(M′)=H(M).

Thus, a one-way hash function is a deterministic algorithm that compresses an arbitrary long message into a value of specified length—often referred to as a ‘fingerprint’—such that it is infeasible to find two distinct messages that have the same fingerprint. Such functions are widely used in cryptography; popular methods include MD5, SHA and Snefru.

The significance of the one-way hash function is that, although a reverse engineer may be able to determine the required result of evaluating the function, there is no easy way to determine the input value that will give rise to that result.

A simple destination function D based upon a Hash function H is:

Function D(C)
{
if H(C) = MD then return 1 else return 2
}

where MD is a predetermined, constant Message Digest value defined as the result of evaluating H(C) for the correct unlock code. Since H is not invertible, it will not be easy for a reverse engineer to determine the value of C that will cause the destination function to jump to the restricted content. However, it would still be relatively easy for a reverse engineer to substitute or eliminate the hash function above since the desired destination (namely, ‘1’) is easy to determine from the code.

### EXAMPLE 6

A more secure destination function would rely on having a relatively large number of apparently valid destinations available. For example, suppose a function D(C) takes as input a four-digit PIN code. A DVD may be authored on which there are 10,000 possible destinations, of which 9,999 give “Access Denied” responses, and 1 results in access to the restricted content. This can be accomplished by the following trivial destination function:

Function D(C)
{
return C
}

Thus, security here is related to how easy it may be for a reverse engineer to identify the protected content amongst a large collection.

A security weakness then becomes the technique used to determine the code used to unlock the correct destination.

### EXAMPLE 7

Another exemplary technique involves using a pair of keys as parameters to the destination function, with one key being generated by the player, and the second matching key being provided by the URC. One implementation of this approach may operate as follows:
1. The user plays the DVD, which generates a random access key C₁ in the form, say, of a four digit PIN. The code is displayed on screen.
2. The user enters the access key C₁ into the URC.
3. The URC generates a replay key C₂ (also a four digit PIN) using the access key C₁ and a function, which, in effect, is the inverse of the destination function. In this case, the inverse destination function is stored as program instructions in the fourth NV memory. The instructions can come pre-loaded on the URC or be downloaded over a telephone line.
4. The URC transmits C₂ to the DVD player, which internally causes a destination to be evaluated as D(C₁, C₂).
5. The DVD jumps to the calculated destination.

Here, an exemplary destination function is:

Function D(C₁, C₂)
{
return (C₁ + C₂) mod 10000
}

In this case, an inverse destination function, programmed into the URC, is as follows, assuming that the correct destination is D_{unlock}:

C₂=(D_{unlock}−C₁)mod 10000 (Note: 0≦C₂<10000)

For example, if the correct destination is 1234 and the DVD player presents a code of 5678, then the corresponding code in the URC required to unlock the content is (1234−5678)mod 10000=5556.

### EXAMPLE 8

Another example by which the destination is unlocked is represented by the following pseudo code:

```
    Ref = RND(10,000) # Generate a random number 0... 9,999
    Display Ref
    Prompt for Key # ‘Key’ is a 4-digit unlock key entered by
the user
    Destination = (Ref XOR Key) mod 1000 + 1 # The target PGC in the
range 1... 1000
Jump to valid DVD sequence destination
```

In the above, the DVD player displays a random access key. The user enters the access key into the URC, which calculates a replay key using:

Key=D XOR Ref,

where ‘D’ is the correct destination—321 in this example. The URC transmits this key to the DVD player, which calculates the destination and executes a jump to the corresponding valid sequence instruction.

Note that PIN codes above are used for illustrative purposes; in practice longer codes may be appropriate to provide high levels of security. The destination function illustrated is very simple and insecure; in practice a one-way hash function would be preferable so that it cannot be easily inverted.

The advantages of this method are:
1. The destination code cannot easily be determined from examination of the instructions on the DVD,
2. each time the DVD is played a different code will be generated requiring a distinct unlock code.

A disadvantage is that a reverse engineer who is aware of a matching pair of codes that unlock the DVD could create a copy of the DVD, and replace the instructions that generate the random number with instructions that always generate the known generated key. This new DVD can then always be unlocked using the known unlock key from the matching pair.

### EXAMPLE 9

Another enhancement of the method is to apply a non-invertible transformation to the true originating code C₁ in order to ‘hide’ this code. That is, the true originating code C₁ acts as a seed to generate the first access key C₁′ displayed to a user. In which case, a modified implementation would be:
1. The user plays the DVD, which generates a random access key C₁ in the form of, say, a four digit PIN.
2. A (non-invertible) transformation T is applied to C₁ to yield C₁=T(C₁) and this transformed code is displayed on screen.
3. The user programs the value of C₁′ into the URC.
4. Using a large, pre-calculated lookup table 338 containing all possible codes and their corresponding transformed values, which is stored in the fourth NV memory 335, the generator 301 performs a table lookup to derive C₁ from the supplied C₁′.
5. Using the derived C₁ value the generator 301 then applies a function (also stored in the fourth NV memory 335) to generate a matching code C₂, which is also, say, a four digit PIN.
6. The URC then transmits C₂ to the DVD player, which internally causes a destination to be evaluated as D(C₁, C₂). (Note: the value C₁′ is no longer required).
7. The DVD player then jumps to the calculated valid sequence instruction.

An advantage of this method over the previous examples is that the exposed values C₁′ and C₂ are not sufficient to unlock the disc content, but require the pre-transformed value C₁, which cannot easily be derived from the exposed values. This is because, even though a reverse engineer could determine the method used by transformation T, this transformation is not invertible. The inverse transformation must be performed by the URC, where it is achieved through table lookup. Typically this table will be very large, and hence offers a high degree of high security. However, for even greater security, it would be preferable for there to be some interaction with the vendor (or their agent) in order to generate C₂, since it is in principle still possible for a reverse engineer to decipher and replicate the operation of the URC. For example, the process may be adapted so that it is necessary to contact the vendor to acquire a key, which enables the URC to select a correct entry in the lookup table. Other appropriate scenarios will be apparent to the skilled reader.

The foregoing examples have the advantage that a URC is programmed to, in effect, unlock restricted content stored on a DVD. In principle, a reverse engineer would need to replicate the operation of the URC as well as reproduce the DVD in order to benefit from being able to ‘copy’ the DVD content. This places a relatively high barrier in front of a reverse engineer, who may simply decide it is not worthwhile attempting to copy DVD content that is protected in this way.

According to further embodiments of the present invention, which will hereafter be described, secure access control in a DVD can be achieved by using an obscured menu, as described herein, in addition to hiding a correct playback sequence instruction among many other playback instructions, as already described above with reference to the applicant's three co-pending international patent applications WO2004109680, WO2004109678 and WO2004109679. The embodiments also require use of an appropriately programmed URC. This is because, the menu buttons are programmed with a time limit, for activating or moving away therefrom, meaning that it is impractical for a normal user to manually navigate through the menu hierarchy, let alone find the correct sequence instruction. If the user does not act within the time limit, the process is cancelled, or the user is taken back to a starting menu button. Before describing the embodiments in detail, one way of obscuring, or obfuscating, audiovisual content will be described with reference to the diagrams in FIGS. 14 and 15. Other ways of obscuring the content will be evident from the descriptions in the aforementioned three co-pending patent applications.

FIG. 14a illustrates a sequence of cells 420a, which are each numbered with their playback order 1-20. As shown, the cells have been jumbled so that they are not in the correct playback order. In addition, four ‘red herring’ cells 422 (the shaded cells) have been included in the sequence. Red herring cells contain content that is similar to the genuine content, so that they appear to a reverse engineer to contain genuine content, but not part of the genuine content. Also shown in FIG. 14a is a ‘correct’ sequence instruction, in this case a PGC 410a, containing 20 cell pointers, numbered 1 to 20. During playback, the cell pointers are read in sequence to determine which cell to play next. According to the cell pointers 1-20 in the PGC 410a, the playback cell order is “1,2,3,4,5,6,7,8,9,10,11,12,13,14,15,16,17,18,19,20”. In other words, the cells are replayed in the correct order, using this PGC, and red herring cells are avoided.

The diagram in FIG. 14b illustrates the same arrangement of cells as in FIG. 14a, but this time associated with an ‘incorrect’ sequence instruction, PGC 410b, which has 24 cell pointers numbered 1 to 24. According to the cell pointers of the PGC 410b, the cell playback order is “3,1,2,red herring,6,5,4,red herring,8,7,12,9,11,10,red herring,13,15,14,red herring,17,19,16,20,18”. In other words, the cells are replayed in the wrong order. In addition, the red herring cells are replayed. The combination of erroneous cell playback order interspersed with red herring content is expected to render playback thoroughly unsatisfactory for the viewer.

In a practical embodiment, there would be many hundreds or even thousands of incorrect PGCs, which would be variations of the PGC in FIG. 14b, so that a reverse engineer would be unable, without significant experimentation, to find the correct PGC 410a. An exemplary PGC arrangement is illustrated in the diagram in FIG. 15, wherein 1000 PGCs are stored in a Video Title Set 424 and the sole correct PCG 410a is PGC number 321.

According to a first example, a DVD has a hierarchical, obscured menu structure, for example having three tiers as described with reference to FIG. 9. In this example, there are many paths through the menu structure to the lowest menu tier. However, there is only one valid path through the hierarchy, which is, in effect, hidden from users and reverse engineers alike by the many other paths. The menu buttons in the lowest tier of the menu hierarchy, when activated, each point to a playback sequence instruction, but only one menu button points to the correct sequence instruction.

In this example, the user possesses a URC of the kind described above and programs the URC with the correct menu navigation path by, for example, purchasing and loading menu path information into the URC. The path information may be purchased from a vendor and delivered over a telephone line, in a process similar to the one described above for acquiring a lookup table, or added to the URC using a smart card or the like (as will be descried hereinafter). The path information comprises a sequence of arrow key codes, which correspond to the appropriate sequence of up, down, left and right arrow and OK key presses that are required to navigate through the menu. The sequence of codes is stored in the URC and transmitted, for example, by pressing the hidden content key “H” 235 of the URC. The DVD player receives the code sequence signals and moves through the menu to the last menu button in the sequence. This menu button is activated by a final OK key press code in the signal and the DVD player jumps to the sequence instruction pointed at by the menu button.

The aforementioned method is useful in pay-once-play-many-times scenarios, although it suffers from the disadvantage that a user can pass the sequence to others, for example by programming a normal ‘learning mode’ URC to receive and reproduce the code sequence.

According to a second example, an improved method uses a URC that is programmed with many path sequences, for example which are stored in a lookup table in the fourth NV memory of the URC. In addition, the DVD is arranged to generate and display a random number C₁ when playback is initiated, as in previous examples. The user enters the random number C₁ into the URC and the generator 301 uses the random number C₁ to select one from the many alternative path sequences to transmit to the DVD player, for example when the hidden content “H” button 235 is pressed. The generator 301 selects the appropriate path using a function X(C₁)=Pn (where n is in the range 1 to the number of stored paths). In its simplest form, the function X(C₁) may select the path sequence in the lookup table that is the C₁^{th} sequence in the list of sequences. For example, if the random number C₁ is 3456, the function X(C₁) may simply select the 3456^{th} entry in the lookup table 338. However, more elaborate functions may provide stronger security.

The DVD is programmed with an obscured menu hierarchy similar to the one in the previous example, having plural menus in plural tiers. In this example, there remain many paths through the menu structure, however, no one path is designated as the correct path. Each menu button in the menus on the lowest tier is programmed, when activated, to load a different number C₂ into a register of the DVD player. Additionally, there remain many different sequence instructions on the DVD, only one of which D_{unlock} causes playback in the correct sequence. In operation, playing the DVD causes the DVD player to generate and display the random number C₁, which the user enters into the URC. The user then presses the hidden content key “H” 235 of the URC, and the generator 301 selects and transmits the sequence of key codes to the DVD player, which causes navigation through the menu hierarchy. Activation of the final menu button causes an associated number C₂ to be loaded into the DVD player register and the DVD player calculates the location of the valid sequence data using a simple destination function D_{unlock}=D(C₁, C₂). In effect, the menu hierarchy behaves as a lookup table, returning a number C₂ in response to selection of a path through the menu hierarchy. The functions X(C) and D(C) may be unrelated and all possible outcomes of the functions can be generated in advance and used to generate the menu paths and resulting numbers C₂, which can then be arranged as appropriate DVD content defining the obscured menu.

In a further example, an obscured menu comprises a plurality of buttons each programmed, when activated, to load a number into a register of the DVD player. The buttons may be arranged in plural menus and plural tiers if required. There are many alternate possible paths between menu buttons and no one path is designated as the correct path. A URC according to this example is arranged so that the fourth NV memory contains a large number of menu path code sequences, each being a viable path of the menu.

As with earlier embodiments, DVD playback causes the DVD player to generate and display a random number C₁, which acts as an access key. The user enters the access key, say 345 in this example, in the URC. The user then presses the hidden content button “H” 235, which causes the generator 301 to select, say, the 345^{th} entry from the lookup table and transmit the entire respective menu path code sequence to the DVD player. The sequence causes the DVD player to navigate through the menu structure and activate all (or at least some selected) menu buttons along the way, thereby generating a replay key C₂. The replay key C₂ may simply comprise the sequence of numbers in the order they are generated by the menu buttons or a simple function of the numbers. When the last menu button has been activated, the DVD player uses a function D(C₁, C₂) to identify and jump to the valid sequence instruction to replay the respective restricted content. A function uses the access key C₁ and the replay key C₂ to derive the location of the valid sequence data using a simple mathematical function, for example an XOR function.

The present inventors suggest that DVD-Video authoring software, such as DVD-EXTRA STUDIO™, can be arranged to generate an obscured menu automatically, for example in response to the definition by a programmer of various parameters, such as random number range, number of buttons in a menu, number of menus or tiers of menus and appropriate destination functions. For example, a number of standard menu templates may be provided for this purpose. The software may then generate an obscured menu or entire menu hierarchy, using the teachings that are provided herein, which can then form part of the content of a respective DVD. Indeed, in embodiments where the audiovisual content is obscured, an additional step of that process may be to provide an obscured menu or menu hierarchy, as described herein.

Although the preferred embodiments of the present invention have been described herein with particular reference to the DVD-Video format, it will be appreciated that the invention is applicable to a wide variety of other environments, particularly where audiovisual content is stored in some form of random access storage media. Also, it is envisaged that the DVD-Video format will itself be superseded over time and replaced with new format definitions. That is, the present invention is likely to be applicable even in some future and as yet unrealised environments.

FIG. 16 shows an example authoring apparatus as may be employed in preferred embodiments of the present invention. In this embodiment, the authoring apparatus includes a computing platform such as a client-server computer system, or a stand-alone personal computer 1630. Optionally, raw audio and video data are received, such as through a camera 1610 and a microphone 1620, or are provided from other sources such as a file storage device 1625, or are created within the authoring apparatus such as by image and sound creation software. The raw content data may include video clips, audio clips, still picture images, icons, button images and other visual content to be presented onscreen. The content is suitably in the form of MPEG or JPEG encoded files, but may take any suitable format.

This original audiovisual data can take any form such as a movie, or a company presentation, or a quiz game, amongst many other possibilities. The personal computer 1630 acting as the authoring apparatus creates the desired audiovisual product using the procedures that have already been described. The computing platform 1630 writes the audiovisual product 1645 onto a storage medium such as a hard disk drive within the personal computer 1630 or onto an optical disk 1640.

FIG. 17 shows a structure of the audiovisual product 1740 in more detail. The audiovisual product 1740 includes a plurality of cells 410, in this case represented by cells AV1, AV2 . . . AVm. Each cell 410 contains a short section of audiovisual data. The cells are played in sequence, typically one after the other, in order to deliver the intended audiovisual representation, under control of a playback sequence instruction 410. The sequence instructions 410 as shown in FIG. 26 are separate from the cells 420. Suitably, the cells 420 and the sequence instructions 410 are each allocated to structure locations within the audiovisual product, so as to enable navigation between instructions 410 and from instructions 410 to cells 420.

In the preferred example of DVD-Video format data, the cells 420 are played in sequence through their inclusion by reference in programs (PGs), which are in turn organised into Program Chains (PGCs). In FIG. 17, the sequence instructions 410 are represented by Program Chains PGC1, PGC2 . . . PGCn. Preferably, each cell 420 contains at least one video stream, at least one audio stream, and/or at least one sub-picture stream. Menu information is interleaved into the video streams.

As illustrated in the diagram in FIG. 18, in alternative embodiments of the present invention, a URC 1800 is adapted by inclusion of a slot 1810 to receive a token, for example a smart card 1820. The URC 1800 and smart card 1820 are mutually adapted in a known way so that the URC can communicate, via contacts 1830 of the smart card, with an embedded memory or processor (not shown) of the smart card. The smart card 1820 may comprise a memory circuit, which acts as the fourth NV memory 335 of the URC. In other words, in this example, the URC may not have a fourth NV memory of its own. The memory circuit may have stored therein any one or more of the aforementioned lookup tables or functions that can be accessed by the generator 301 of the URC. Alternatively, the smart card may comprise an embedded processor, for example, which receives an access key from the URC and, in response, returns a replay key; which is then transmitted by the URC to the DVD player in order to unlock the restricted content. In this way, instead of being part of the URC, the generator would be provided by the smart card 1820. A smart card or the like could be provided with a DVD or purchased separately.

For example, in some commercial scenarios, the DVD could be provided free of charge as a cover disc on a magazine, or the like. The DVD might contain some free content, which can be accessed by normal playback of the DVD, and restricted content, which requires additional access to be purchased in some way. The access could be provided by purchasing and downloading a replay key or the like over the telephone, or by purchasing a smart card or other token, which is used to program an appropriate URC to access the content.

Although a few embodiments and examples have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An audiovisual product, comprising audiovisual content, including protected audiovisual content and a menu component, which provides access during playback of the audiovisual content to the protected audiovisual content, wherein the menu component comprises one or more on-screen menus comprising plural menu buttons and access to the protected audiovisual content is provided by selecting menu buttons in a predetermined sequence.

2. An audiovisual product according to claim 1, wherein the menu buttons of the predetermined sequence are provided in one menu of the menu component.

3. An audiovisual product according to claim 1, wherein the menu buttons of the predetermined sequence are provided in two or more menus of the menu component.

4. An audiovisual product according to claim 3, wherein a menu button of the sequence in a first menu provides access to a second menu comprising one or more other menu buttons of the sequence.

5. An audiovisual product according to claim 1, wherein selecting a next menu button of the sequence depends on moving in a correct on-screen direction away from a current menu button of the sequence.

6. An audiovisual product according to claim 1, wherein selecting each next menu button of the sequence depends on moving in a correct on-screen direction away from each respective current menu button of the sequence.

7. An audiovisual product according to claim 5, wherein attempted movement in an on-screen direction away from at least one menu button, which direction is not in accord with the sequence, results in no movement away from the menu button.

8. An audiovisual product according to claim 6, wherein attempted movement in an on-screen direction away from at least one menu button, which direction is not in accord with the sequence, results in movement to a menu button from where no further movements according to the sequence can occur.

9. An audiovisual product according to claim 5, wherein attempted movement in an on-screen direction away from at least one menu button, which direction is not in accord with the sequence, results in an out-of-sequence movement to a menu button, which is earlier in the sequence or not part of the sequence.

10. An audiovisual product according to claim 1, wherein movement between at least one menu button of the sequence is counter-intuitive.

11. An audiovisual product according to claim 1, wherein movement in an on-screen direction away from at least one menu button of the sequence results in selection of a menu button, which is located on screen in a different on-screen direction.

12. An audiovisual product according to claim 1, wherein at least two of the menu buttons at least partially overlap on screen.

13. An audiovisual product according to claim 1, wherein at least two of the menu buttons significantly overlap on screen.

14. An audiovisual product according to claim 1, wherein at least one of the menu buttons of the sequence is obscured or suppressed.

15. An audiovisual product according to claim 1, wherein at least one of the menu buttons of the sequence is indistinguishable from its background or surroundings.

16. An audiovisual product according to claim 1, wherein at least one of the menu buttons of the sequence is transparent and/or invisible.

17. An audiovisual product according to claim 1, wherein there is a time limit associated with at least one of the menu buttons of the sequence.

18. An audiovisual product according to claim 17, wherein selecting said menu button, and not moving away from said menu button, for a time exceeding the time limit, prevents or hinders access to the protected audiovisual content.

19. An audiovisual product according to claim 18, wherein selecting said menu button, and not moving away from said menu button, for a time exceeding the time limit prevents or hinders access to the protected audiovisual content by activating the selected menu button.

20. An audiovisual product according to claim 19, wherein activating the selected menu button causes selection of a different menu button, which is not in accord with the sequence, or causes playback of audiovisual content that is not the protected audiovisual content.

21. An audiovisual product according to claim 1, wherein access to the protected audiovisual content is enabled including by activating at least one menu button of the sequence.

22. An audiovisual product according to claim 1, wherein access to the protected audiovisual content is enabled including by activating the last menu button of the sequence.

23. An audiovisual product according to claim 1, wherein access to the protected audiovisual content is enabled including by activating more than one menu button of the sequence.

24. An audiovisual product according to claim 23, wherein each menu button of the sequence that is activated contributes towards generating an access code for use in accessing the protected audiovisual content.

25. An audiovisual product according to claim 23, wherein each button of the sequence that is activated modifies one or more runtime variables.

26. An audiovisual product according to claim 25, wherein access to the protected audiovisual content is enabled including by determining if the or each runtime variable has a predetermined value.

27. An audiovisual product according to claim 1, wherein selecting the menu buttons in the predetermined sequence, and activating zero or more of the buttons, identifies information for accessing the protected audiovisual content.

28. An audiovisual product according to claim 1, wherein selecting the menu buttons in the predetermined sequence, and activating zero or more of the buttons, at least contributes to the generation of a destination function, for use in accessing the protected audiovisual content.

29. An audiovisual product according to claim 1, wherein the protected audiovisual content comprises plural portions, which are arranged so that an acceptable playback order of the portions is obscured, and a significant number of playback instructions, of which only one, or a relative minority, identify or cause an acceptable playback of the portions.

30. An audiovisual product according to claim 29, wherein an acceptable playback of the portions is obscured by at least one of: incorrectly ordering the portions; mixing said portions with dummy portions; and providing plural possible playback paths.

31. An audiovisual product according to claim 29, wherein selection of a correct playback instruction results from selecting, and/or activating zero or more menu buttons of the predetermined sequence.

32. An audiovisual product according to claim 1, wherein the protected audiovisual content comprises a plurality of cells, arranged in a non-sequential playback order, and a plurality of playback sequence instructions, only one (or a minority) of which define(s) a correct cell playback sequence, and wherein access to a correct playback sequence instruction is via selecting and/or activating menu buttons of the predetermined sequence.

33. An audiovisual product according to claim 1, wherein at least one menu button of the sequence is an auto-activation button.

34. A remote controller, for controlling audiovisual content playback apparatus to playback audiovisual content, including protected audiovisual content, arranged according to any one of the preceding claims, wherein the remote controller is arranged to generate control signals for controlling the audiovisual content playback apparatus to select the menu buttons in said predetermined sequence.

35. A remote controller according to claim 34, arranged to generate control signals for selecting more than one of the menu buttons according to said predetermined sequence.

36. A remote controller according to claim 34, arranged to generate control signals for selecting a majority or all menu buttons according to said predetermined sequence.

37. A remote controller according to claim 34, arranged to generate said control signals in response to respectively fewer, or only one, user interaction.

38. A remote controller according to claim 34, comprising means for receiving access information associated with the protected audiovisual content and using received access information for generating the control signals, for controlling the audiovisual apparatus to playback the protected audiovisual content.

39. A remote controller as claimed in claim 38, arranged, using the access information, to execute a pre-defined function for generating the control signals.

40. A remote controller according to claim 34, arranged to store data defining one or more pre-defined functions.

41. A remote controller according to claim 34, storing a lookup table.

42. A remote controller according to claim 41, wherein the lookup table contains plural playback data entries.

43. A remote controller according to claim 42, arranged to access the lookup table and retrieve an item of playback data, determined by the access information, to be used to generate the control signals.

44. A remote controller according to claim 34, arranged to receive and store one or more lookup tables or respective entries.

45. A remote controller according to claim 34, arranged to receive and store user data.

46. A remote controller according to claim 45, arranged to generate the control signals using the user data.

47. A remote controller according to claim 34, comprising a receiver for receiving remotely transmitted access information.

48. A remote controller according to claim 47, wherein the receiver is receptive to playback of audiovisual content.

49. A remote controller according to claim 34, comprising a token reader.

50. A remote controller according to claim 49, wherein the token reader is adapted to read information from a received or nearby token.

51. A remote controller according to claim 49, wherein the token reader is adapted to interact with a received or nearby token.

52. A remote controller according to claim 34, arranged to generate an access key.

53. A remote controller according to claim 34, arranged to generate control signals comprising a sequence of menu navigation codes.

54. A remote controller according to claim 34, arranged to generate control signals comprising a sequence of menu navigation codes including zero or more menu button activation codes.

55. A remote controller, for controlling audiovisual content playback apparatus to playback audiovisual content, including protected audiovisual content, wherein the remote controller is arranged to control the audiovisual content playback apparatus to select the protected audiovisual content for playback including by interacting with plural menu buttons of an obscured or hidden on-screen menu.

56. A storage device or apparatus storing an audiovisual product according to claim 1.

57. A removable storage medium comprising an audiovisual product according to claim 1.

58. An optical disc product according to claim 57.

59. A DVD product according to claim 58.

60. A remote controller according to claim 34, adapted to control audiovisual content playback apparatus to playback audiovisual content, which is at least initially stored on one of: a hard disc apparatus; a removable memory device; an optical disc product, or a DVD product.

61. A remote controller for controlling audiovisual apparatus to playback restricted audiovisual content, the controller comprising means for receiving access information associated with the restricted audiovisual content, generator means for generating playback data, using received access information, and transmitter means for transmitting a playback signal, embodying the playback data, for controlling the audiovisual apparatus to playback the restricted audiovisual content.

62. A remote controller according to claim 61, wherein the generator is arranged to execute a pre-defined function to calculate the playback data using the access information as an input to the pre-defined function.

63. A remote controller according to claim 61, wherein the generator comprises a processor programmed with the function, which is executed by the processor in response to an event.

64. A remote controller according to claim 63, wherein the event comprises an input by a user of the access information.

65. A data storage medium storing audiovisual content, the content comprising one or more audiovisual components, including at least one protected audiovisual component, and a menu component, which provides limited access during playback of the content to the protected audiovisual component, via at least one path defined by plural menu buttons, wherein the menu component has an associated time limit, and access to the protected audiovisual content via the path is permitted only within the time limit.

66. A method of manufacturing an audiovisual product, including the step of authoring protected audiovisual content according to claim 1.

67. A method of accessing protected audiovisual content, arranged according to claim 1, including the step of providing control signals to control content playback apparatus to select, and activate zero or more of, the menu buttons in said predetermined sequence.
